(19) United States
(12) Patent Application Publication
(10) Pub. No.: US 2026/0245913 A1
(43) Pub. Date: Aug. 20, 2026

(54) CATHODE MIXTURE, SECONDARY BATTERY INCLUDING THE CATHODE MIXTURE AND METHOD OF PREPARING THE CATHODE MIXTURE

(71) Applicants: Samsung Electronics Co., Ltd., Suwon-si (KR); CHUNBO CO., LTD., Chungju-si (KR)

(72) Inventors: Sewon Kim, Suwon-si (KR); Kwanwook Song, Chungju-si (KR); Sangjin Lee, Chungju-si (KR); Yongsu Kim, Suwon-si (KR); Taehee Kim, Suwon-si (KR)

(21) Appl. No.: 19/539,906

(22) Filed: Feb. 13, 2026

(30) Foreign Application Priority Data
Feb. 17, 2025 (KR) 10-2025-0020383

(51) Int. Cl. H01M 4/66; H01M 4/525

(52) U.S. Cl. CPC H01M 4/661; H01M 4/525

(57) ABSTRACT

A cathode mixture, a secondary battery including the cathode mixture, and a method of preparing the cathode mixture. The cathode mixture includes a cathode active material and a cathode electrolyte, and the cathode electrolyte includes a flame retardant liquid and an ionic liquid, the flame retardant liquid including a compound represented by Formula 1.

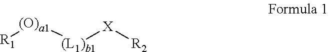

In Formula 1,
R₁ is a C₁-C₁₀ alkyl group substituted with fluorine,
R₂ is a C₁-C₁₀ alkyl group that is unsubstituted or substituted with fluorine,
a1 is 0 or 1,
b1 is 0 or 1,
L₁ is a C₁-C₁₀ alkylene group that is unsubstituted or substituted with fluorine, and
X is a carbonyl group (—CO—), an ester group (—COO—), a sulfonate group (—SO₃—), or a sulfonyl group (—SO₂—).

### CROSS-REFERENCE TO RELATED APPLICATION

This application claims priority to Korean Patent Application No. 10-2025-0020383, filed on Feb. 17, 2025, in the Korean Intellectual Property Office, and all the benefits accruing therefrom under 35 U.S.C. 119, the contents of which are incorporated by reference herein in their entirety.

### BACKGROUND

### 1. Field

The disclosure relates to a cathode mixture, a secondary battery including the cathode mixture, and a method of preparing the cathode mixture.

### 2. Description of the Related Art

Secondary batteries, such as lithium secondary batteries, may provide improved specific energy (Wh/kg) and/or energy density (Wh/cc).

Secondary batteries may include solid electrolytes for improved stability. When a secondary battery adopts a solid electrolyte, for example, the interfacial resistance between the cathode and the solid electrolyte may be increased.

### SUMMARY

Accordingly, there is an ongoing need to improve a cathode mixture such that it is capable of reducing the interfacial resistance between the cathode and the solid electrolyte.

Provided is a cathode mixture including a flame retardant liquid and an ionic liquid having a novel composition.

Provided is a secondary battery including the cathode mixture.

Additional aspects will be set forth in part in the description which follows and, in part, will be apparent from the description, or may be learned by practice of the presented embodiments of the disclosure.

According to an aspect of the disclosure,
a cathode mixture includes a cathode active material, and
a cathode electrolyte,
wherein the cathode electrolyte includes a flame retardant liquid, and an ionic liquid, and
the flame retardant liquid includes a compound represented by Formula 1.

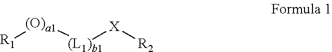

In Formula 1,
R₁ is a C₁-C₁₀ alkyl group substituted with fluorine,
R₂ is a C₁-C₁₀ alkyl group that is unsubstituted or substituted with fluorine,
a1 is an integer of 0 or 1,
b1 is an integer of 0 or 1,
L₁ is a C₁-C₁₀ alkylene group that is unsubstituted or substituted with fluorine,
X is a carbonyl group (—CO—), an ester group (—COO—), a sulfonate group (—SO₃—), or a sulfonyl group (—SO₂—).

According to another aspect of the disclosure,
a secondary battery includes a cathode, an anode, and
a solid electrolyte disposed between the cathode and the anode,
wherein the cathode includes a cathode current collector and
a cathode active material layer disposed between the cathode current collector and the solid electrolyte, wherein the cathode active material layer includes the cathode mixture.

According to another aspect of the disclosure,
a method of preparing a cathode mixture includes preparing a cathode active material and a cathode electrolyte, and
injecting the cathode electrolyte into the cathode active material,
wherein the cathode electrolyte includes a flame retardant liquid, and an ionic liquid, and
the flame retardant liquid includes a compound represented by Formula 1.

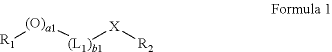

In Formula 1,
R₁ is a C₁-C₁₀ alkyl group substituted with fluorine,
R₂ is a C₁-C₁₀ alkyl group that is unsubstituted or substituted with fluorine,
a1 is an integer of 0 or 1,
b1 is an integer of 0 or 1,
L₁ is a C₁-C₁₀ alkylene group that is unsubstituted or substituted with fluorine, and
X is a carbonyl group (—CO—), an ester group (—COO—), a sulfonate group (—SO₃—), or a sulfonyl group (—SO₂—).

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic illustration of the structure of a cathode mixture according to an embodiment;

FIGS. 2 to 8 are schematic illustrations of the structure of a secondary battery according to an embodiment;

FIG. 9 is a graph of charge/discharge profile of a secondary battery according to Example 1, graphing the cell voltage (V) as a function of areal capacity (milliAmperes per square centimeter, mA/cm²) at different current densities;

FIG. 10 is a graph of charge/discharge profile of a secondary battery according to Example 2, graphing the cell voltage (V) as a function of areal capacity (mA/cm²) at different current densities;

FIG. 11 is a graph of charge/discharge profile of a secondary battery according to Comparative Example 1, graphing the cell voltage (V) as a function of areal capacity (mA/cm²) at different current densities;

FIG. 12 is an X-ray Photoelectron Spectroscopy (XPS) depth profile analysis of the surface of a solid electrolyte layer adjacent to the cathode after charge and discharge of the secondary battery according to Example 1, in which counts per second (intensity) is measures as a function of binding energy (eV) at various sputter times;

FIG. 13 is an XPS depth profile analysis of the surface of a solid electrolyte layer adjacent to the cathode after charge and discharge of the secondary battery according to Example 2, in which counts per second (intensity) is measures as a function of binding energy (eV) at various sputter times;

FIG. 14 is an XPS depth profile analysis of the surface of a solid electrolyte layer adjacent to the cathode after charge and discharge of the secondary battery according to Comparative Example 1, in which counts per second (intensity) is measures as a function of binding energy (eV) at various sputter times;

FIG. 15 is an XPS position profile analysis of the surface of a solid electrolyte layer adjacent to the cathode after charge and discharge of the secondary battery according to Example 1, in which counts per second (intensity) is measures as a function of binding energy (eV) at various sputter times;

FIG. 16 is an XPS position profile analysis of the surface of a solid electrolyte layer adjacent to the cathode after charge and discharge of the secondary battery according to Example 2, in which counts per second (intensity) is measures as a function of binding energy (eV) at various sputter times; and

FIG. 17 is an XPS position profile analysis of the surface of a solid electrolyte layer adjacent to the cathode after charge and discharge of the secondary battery according to Comparative Example 1, in which counts per second (intensity) is measures as a function of binding energy (eV) at various sputter times.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Unless otherwise defined, all terms (including technical and scientific terms) used herein have the same meaning as commonly understood by one of ordinary skill in the art to which the disclosure belongs. Additionally, terms defined in commonly used dictionaries should be interpreted as having a meaning consistent with their meaning within the context of the relevant art and the disclosure, and not in an idealized or overly formal sense.

Embodiments are described in the disclosure with reference to cross-sectional drawings which are schematic drawings of idealized embodiments. Accordingly, variations from the shapes depicted in the drawings as a result of, for example, manufacturing techniques and/or tolerances, are to be expected. Therefore, the embodiments described herein should not be construed as limited to the specific shapes of regions as illustrated in the drawings, but are to include deviations in shapes that result, for example, from manufacturing. For example, a region illustrated or described as flat may typically have rough and/or nonlinear features. Furthermore, sharp angles that are illustrated may be rounded. Therefore, the regions shown in the drawings are inherently schematic in nature and are not intended to precisely depict the actual shape of the regions or to limit the scope of the claims.

The inventive concept may be embodied in many different forms and should not be construed as limited to the embodiments set forth herein. The embodiments are provided so that this disclosure is thorough and complete and fully conveys the scope of the inventive concept to those skilled in the art. The same reference numerals refer to the same elements throughout the drawings.

When an element is referred to as being “on” another element, it may be directly on the other element or intervening elements may be present therebetween. In contrast, when an element is referred to as being “directly on” another element, there are no intervening elements present.

The terms “first,” “second,” “third,” and so on may be used to describe various elements, components, regions, layers, and/or sections, but these elements, components, regions, layers, and/or sections should not be limited by these terms. These terms are only used to distinguish one element, component, region, layer, or section from another. Thus, a first element, component, region, layer, or section discussed below could be referred to as a second element, component, region, layer, or section without departing from the teachings of the disclosure.

The terminology used herein is for the purpose of describing particular embodiments only and is not intended to be limiting of the inventive concept. The singular forms used herein are intended to include the plural forms including “at least one” unless the context clearly indicates otherwise. The term “at least one” should not be interpreted as limiting to the singular. As used herein, the singular forms “a,” “an,” and “the” are intended to include the plural forms as well, unless the context clearly indicates otherwise. As used herein, the term “and/or” includes any and all combinations of one or more of the associated listed items. The terms “comprises” and/or “comprising,” as used herein, specify the presence of stated features, regions, integers, steps, operations, elements, and/or components but do not preclude the presence or addition of one or more other features, regions, integers, steps, operations, elements, components, and/or groups thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±20%, ±10%, or ±5% of the stated value.

Spatially relative terms such as “beneath,” “below,” “lower,” “above,” “upper,” and the like may be used herein for ease of description to describe one element or feature's relationship to another element or feature. It is to be understood that these spatially relative terms are intended to encompass different orientations of the device in use or operation in addition to the orientation depicted in the drawings. For example, if the device in the drawings is turned over, elements described as “below” or “beneath” other elements or features would then be oriented “above” the other elements or features. Thus, the exemplary term “below” may encompass both above and below orientations. The device may be otherwise oriented (rotated 90 degrees or at other orientations), and the spatially relative terms used herein are to be interpreted accordingly.

As used herein, the term “-based” refers to a component including the named material. For example, “carbon-based” means carbon-containing.

As used herein, the term “group” refers to a group of the periodic table of elements according to the International Union of Pure and Applied Chemistry (IUPAC) Group 1 to Group 18 classification system.

As used herein, the “size” of a particle, unless otherwise defined, refers to the “particle diameter.”

The “particle diameter” of a particle, as used herein, refers to the average diameter if the particle is spherical, and to the average major axis length if the particle is non-spherical. The particle diameter may be measured using a particle size analyzer (PSA). The “particle diameter” of a particle may, for example, refer to an average particle diameter. Unless otherwise explicitly stated, the average particle diameter refers to a median particle diameter (D50). The median particle diameter (D50) refers to a particle size corresponding to a cumulative value of 50%, calculated from the side of the smallest particle size in the cumulative particle size distribution curve, in which particles are accumulated in order from the smallest to the largest. The cumulative value may be, for example, cumulative volume. The median particle diameter (D50) may be measured, for example, by a laser diffraction method. Alternatively, the “average particle diameter” may be measured using software or manually from scanning electron microscope (SEM) images or transmission electron microscope (TEM) images.

As used herein, the term “metal” includes both metals and metalloids such as silicon and germanium, in either elemental or ionic form.

As used herein, the term “alloy” refers to a mixture of two or more metals.

As used herein, the term “cathode active material” refers to a cathode material capable of undergoing lithiation and delithiation.

As used herein, the term “anode active material” refers to an anode material capable of undergoing lithiation and delithiation.

As used herein, “lithiation” and “to lithiate” refer to a process of adding lithium to a cathode active material or an anode active material.

As used herein, “delithiation” and “to delithiate” refer to a process of removing lithium from a cathode active material or an anode active material.

As used herein, “charging” and “to charge” refer to a process of supplying electrochemical energy to a battery.

As used herein, “discharging” and “to discharge” refer to a process of removing electrochemical energy from a battery.

As used herein, the terms “positive electrode” and “cathode” refer to the electrode at which electrochemical reduction and lithiation occur during the discharge process.

As used herein, the terms “negative electrode” and “anode” refer to the electrode at which electrochemical oxidation and delithiation occur during the discharge process.

Hereinafter, a composite solid electrolyte according to an embodiment and a secondary battery including the same will be described in more detail.

### Cathode Mixture

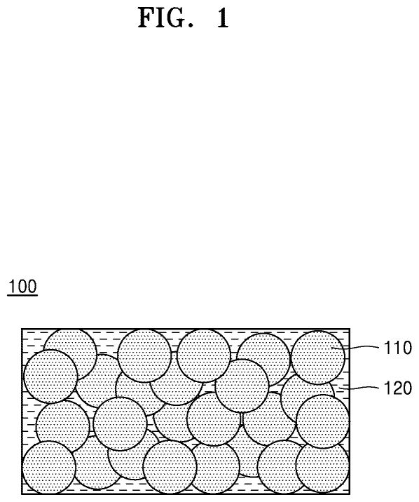

FIG. 1 is a schematic illustration of the structure of a cathode mixture according to an embodiment.

Referring to FIG. 1, the cathode mixture 100 of the disclosure includes a cathode active material 110, and a cathode electrolyte 120, wherein the cathode electrolyte 120 includes a flame retardant liquid, and an ionic liquid, wherein the flame retardant liquid includes a compound represented by Formula 1.

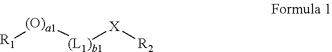

In Formula 1,
R₁ is a C₁-C₁₀ alkyl group substituted with fluorine,
R₂ is a C₁-C₁₀ alkyl group that is unsubstituted or substituted with fluorine,
a1 is an integer of 0 or 1,
b1 is an integer of 0 or 1,

L₁ is a C₁-C₁₀ alkylene group that is unsubstituted or substituted with fluorine, and

X is a carbonyl group (—CO—), an ester group (—COO—), a sulfonate group (—SO₃—), or a sulfonyl group (—SO₂—).

The cathode mixture 100 includes a cathode electrolyte 120 including a flame retardant liquid represented by Formula 1, and may effectively prevent elution of a transition metal contained in the cathode active material 110. Accordingly, the secondary battery 1 including the cathode mixture 100 may exhibit improved charge/discharge characteristics.

According to an embodiment, in Formula 1, R₁ may be a C₁-C₅ alkyl group substituted with fluorine, L₁ may be a C₁-C₅ alkylene group, and R₂ may be a C₁-C₃ alkyl group that is unsubstituted or substituted with fluorine.

According to an embodiment, in Formula 1, R₁ may be —CF₂H, —CF₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CH₂CF₂CF₃, —CF₂CF₂CF₃, —CH₂CF₂CF₂CF₃, —CF₂CF₂CF₂CF₃, —CF₂CF₂CF₂CF₃, —CH₂CF₂CF₂CF₂CF₃ or —CF₂CF₂CF₂CF₂CF₃, and R₂ may be —CH₃, —CF₃, —CH₂CH₃ or —CH₂CF₃.

According to an embodiment, in Formula 1, L₁ may be a methylene group, an ethylene group, a propylene group, or a butylene group.

According to an embodiment, the flame retardant liquid may include at least one of the compounds represented by Formulae 1-1 to 1-6.

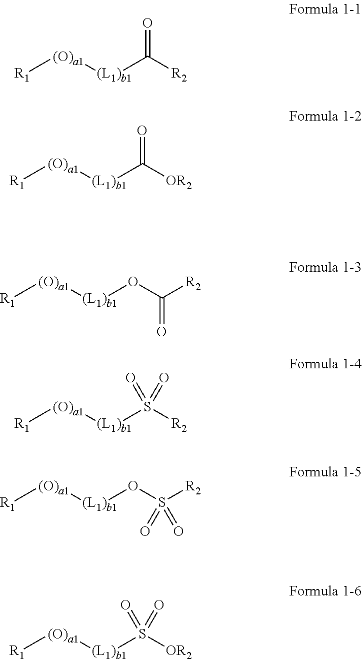

In Formulae 1-1 to 1-6, for descriptions of R₁, a1, L₁, b1 and R₂, reference is made to the aforementioned descriptions.

According to an embodiment, the flame retardant liquid may include least one of the following compounds 1 to 4.

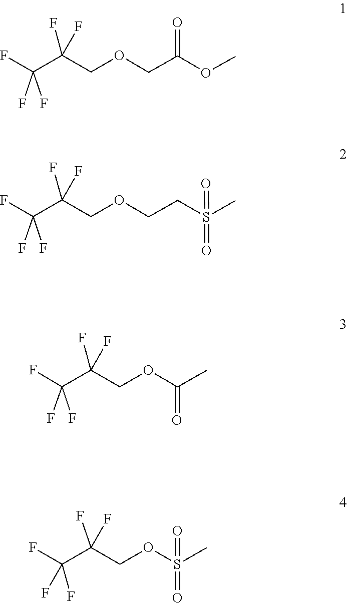

According to an embodiment, the content of the flame retardant liquid may be about 1 vol % to about 50 vol % based on the total volume of the cathode electrolyte.

The content of the flame retardant liquid may be about 10 vol % to about 50 vol %, about 20 vol % to about 50 vol %, about 1 vol % to about 40 vol %, about 1 vol % to about 35 vol %, or about 20 vol % to about 35 vol % based on the total volume of the cathode electrolyte.

According to an embodiment, the cathode mixture may be free of cyano-containing compounds. For example, the cathode electrolyte may be free of cyano-containing compounds.

The cathode electrolyte may include an ionic liquid. By including an ionic liquid in the cathode electrolyte, high-voltage stability may be improved.

The cathode electrolyte comprises an ionic liquid, and the ionic liquid may include, for example, a compound represented by Formulae 1 to 2:

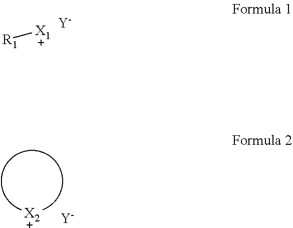

In Formula 1,
X₁ is —N(R₂)(R₃)(R₄) or —P(R₂)(R₃)(R₄),
R₁, R₂, R₃ and R₄ are each independently an unsubstituted or halogen-substituted C₁-C₃₀ alkyl group, an unsubstituted or halogen-substituted C₁-C₃₀ alkoxy group, an unsubstituted or halogen-substituted C₁-C₃₀ alkylthio group, an unsubstituted or halogen-substituted C₆-C₃₀ aryl group, an unsubstituted or halogen-substituted C₆-C₃₀ arylalkyl group, an unsubstituted or halogen-substituted C₆-C₃₀ aryloxy group, an unsubstituted or halogen-substituted C₃-C₃₀ heteroaryl group, an unsubstituted or halogen-substituted C₃-C₃₀ heteroarylalkyl group, an unsubstituted or halogen-substituted C₃-C₃₀ heteroaryloxy group, an unsubstituted or halogen-substituted C₃-C₃₀ heteroarylthio group, an unsubstituted or halogen-substituted C₄-C₃₀ cycloalkyl group, an unsubstituted or halogen-substituted C₃-C₃₀ heterocycloalkyl group, or an unsubstituted or halogen-substituted C₂-C₁₀₀ alkylene oxide group,

In Formula 2,

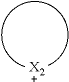

is a heterocycloalkyl ring or a heteroaryl ring containing 1 to 3 heteroatoms and 2 to 30 carbon atoms, wherein the ring is unsubstituted or substituted by a substituent,
X₂ is —N(R₅)(R₆), —N(R₅)═, —P(R₅)(R₆) or —P(R₅)═,
the substituents substituted on the ring, R₅, and R₆ are each independently hydrogen, an unsubstituted or halogen-substituted C₁-C₃₀ alkyl group, an unsubstituted or halogen-substituted C₁-C₃₀ alkoxy group, an unsubstituted or halogen-substituted C₁-C₃₀ alkylthio group, an unsubstituted or halogen-substituted C₆-C₃₀ aryl group, an unsubstituted or halogen-substituted C₆-C₃₀ arylalkyl group, an unsubstituted or halogen-substituted C₆-C₃₀ aryloxy group, an unsubstituted or halogen-substituted C₃-C₃₀ heteroaryl group, an unsubstituted or halogen-substituted C₃-C₃₀ heteroarylalkyl group, an unsubstituted or halogen-substituted C₃-C₃₀ heteroaryloxy group, an unsubstituted or halogen-substituted C₃-C₃₀ heteroarylthio group, an unsubstituted or halogen-substituted C₄-C₃₀ cycloalkyl group, an unsubstituted or halogen-substituted C₃-C₃₀ heterocycloalkyl group, or an unsubstituted or halogen-substituted C₂-C₁₀₀ alkylene oxide group, and
Y⁻ is a counter anion, and each Y individually is BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, PF₆⁻, ClO₄⁻, BOB⁻ (bis(oxalate)borate), CF₃SO₃⁻, CF₃CO₂⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, or (FSO₂)₂N⁻, (CF₃SO₂)₂N. Each Y may be the same or different. Since Y is a counter anion, Y is changeable within the ionic solution.

The cathode electrolyte includes an ionic liquid, and the ionic liquid may include, for example, a compound represented by Formulae 3 to 4:

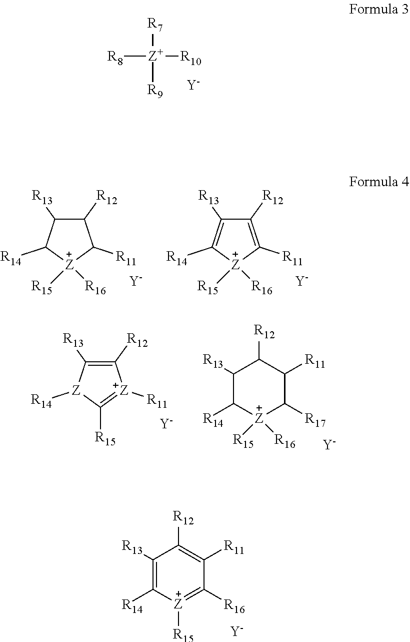

In Formula 3,
Z is N or P,
R₇, R₈, R₉ and R₁₀ are each independently an unsubstituted or halogen-substituted C1-C30 alkyl group, an unsubstituted or halogen-substituted C6-C30 aryl group, an unsubstituted or halogen-substituted C6-C30 arylalkyl group, an unsubstituted or halogen-substituted C3-C30 heteroaryl group, an unsubstituted or halogen-substituted C3-C30 heteroarylalkyl group, an unsubstituted or halogen-substituted C3-C30 heteroaryloxy group, an unsubstituted or halogen-substituted C3-C30 heteroarylthio group, an unsubstituted or halogen-substituted C4-C30 cycloalkyl group, or an unsubstituted or halogen-substituted C3-C30 heterocycloalkyl group,
In Formula 4,
Z is N or P,
R₁₁, R₁₂, R₁₃, R₁₄, R₁₅, R₁₆, and R₁₇ are each independently hydrogen, an unsubstituted or halogen-substituted C1-C30 alkyl group, an unsubstituted or halogen-substituted C6-C30 aryl group, an unsubstituted or halogen-substituted C6-C30 arylalkyl group, an unsubstituted or halogen-substituted C3-C30 heteroaryl group, an unsubstituted or halogen-substituted C3-C30 heteroarylalkyl group, an unsubstituted or halogen-substituted C3-C30 heteroaryloxy group, an unsubstituted or halogen-substituted C3-C30 heteroarylthio group, an unsubstituted or halogen-substituted C4-C30 cycloalkyl group, or an unsubstituted or halogen-substituted C3-C30 heterocycloalkyl group, and
Y⁻ is BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, PF₆⁻, ClO₄⁻, BOB⁻ (bis(oxalate)borate), CF₃SO₃⁻, CF₃CO₂⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, or (CF₃SO₂)₂N. Each Y is the same or different, and since Y is a counter anion, Y is changeable in the ionic solution.

The cathode electrolyte includes an ionic liquid, and the ionic liquid may include, for example, 1-ethyl-1-methylimidazolium bis(fluorosulfonyl)imide, 1-methyl-1-propylpyrrolidinium bis(fluorosulfonyl)imide, 1-methyl-1-butylpyrrolidinium bis(fluorosulfonyl)imide, 1-methyl-1-propylpyrrolidinium bis(trifluoromethanesulfonyl)imide, 1-methyl-1-butylpyrrolidinium bis(trifluoromethanesulfonyl)imide, 1,3,5-trimethyl-1H-imidazol-3-ium bis(fluorosulfonyl)imide, or a combination thereof.

The inclusion of an ionic liquid in the cathode electrolyte may suppress the disadvantages of conventional cathode electrolytes, such as side reactions between the cathode active material and the cathode electrolyte and volatilization of the cathode electrolyte.

The content of the ionic liquid may be from about 50 vol % to about 99 vol % based on the total volume of the cathode electrolyte.

The content of the ionic liquid may be about 50 vol % to about 90 vol %, about 50 vol % to about 80 vol %, about 50 vol % to about 70 vol %, about 60 vo % to about 99 vol %, about 65 vol % to about 99 vol % or about 65 vol % to about 80 vol % based on the total volume of the cathode electrolyte.

According to an embodiment, the cathode electrolyte may further include a lithium salt.

According to an embodiment, the lithium salt may include, for example, at least one of LiPF₆, LiBF₄, LiCF₃SO₃, LiC₂F₅SO₃, LiC₄F₉SO₃, LiN(SO₂F)₂ (LiFSI), LiN(CF₃SO₂)₂ (LiTFSI), LiN(SO₂CF₂CF₃)₂, LiSCN, LiN(CN)₂, Li(CF₃SO₂)₃C, LiCl, LiF, LiBr, LiI, LiB(C₂O₄)₂, LiBF₄, LiBF₃(C₂F₅), LiAsF₆, LiSbF₆, LiClO₄, a compound represented by Formulae 6 to 9 or a combination thereof:

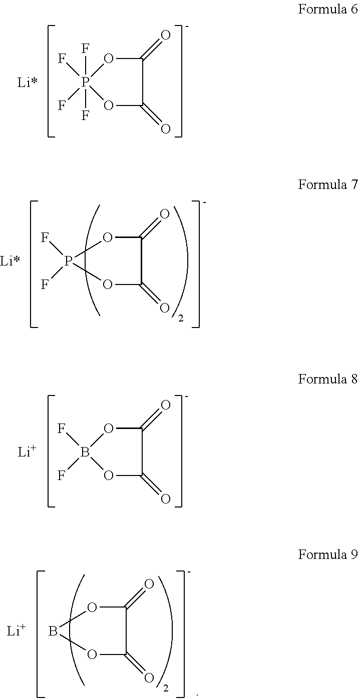

According to an embodiment, the content of the lithium salt may be about 0.1 M to about 5 M, about 0.5 M to about 3 M or about 1 M to about 2.5 M. By including a lithium salt in this range in the cathode electrolyte, the cycle characteristics of a secondary battery including the cathode electrolyte may be further improved.

The cathode electrolyte may further contain a fluorine-containing solvent. The fluorine-containing solvent may include a fluorine-containing carbonate-based solvent, a fluorine-containing ester-based solvent, a fluorine-containing ether-based solvent, or a combination thereof.

The fluorine-containing carbonate-based solvent may include a fluorine-containing cyclic carbonate-based solvent, a fluorine-containing chain carbonate-based solvent, or a combination thereof.

The fluorine-containing cyclic carbonate-based solvent may include, for example, a cyclic carbonate-based compound represented by Formula A.

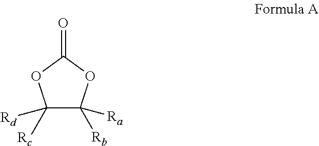

In Formula A, Rₐ, R_{b}, R_{c}, and R_{d} are independently a hydrogen atom, a fluorine atom, a C1-C3 alkyl group, or a fluorine-containing C1-C3 alkyl group,

provided that at least one of Rₐ, R_{b}, R_{c}, and R_{d} is a fluorine atom or a fluorine-containing alkyl group. Examples of fluorine-containing alkyl group include —CF₃, —CH₂F, —CHF₂, —CF₂CF₃, —CH₂CF₃, and —CH₂CH₂F.

The fluorine-containing solvent may include, for example, 1-fluoroethylene carbonate, 1,1-difluoroethylene carbonate, 1,2-difluoroethylene carbonate, 1,1,2-trifluoroethylene carbonate, 1,1,2,2-tetrafluoroethylene carbonate, 1-trifluoromethylethylene carbonate, 1-fluoropropylene carbonate, or a combination thereof.

The fluorine-containing chain carbonate-based solvent may include, for example, a chain carbonate-based compound represented by Formula B.

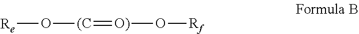

In Formula B, Rₑ and R_{f} are each independently a C₁-C₁₀ alkyl group or a fluorine-containing C₁-C₁₀ alkyl group,

provided that at least one of Rₑ and R_{f} is a fluorine-containing alkyl group. In the fluorine-containing alkyl group, one or more of the hydrogen atoms of the alkyl group may be substituted with fluorine atoms.

The fluorine-containing solvent may include, for example, CF₃CH₂OCOOCH₂CF₃, CF₃CF₂CH₂OCOOCH₂CF₂CF₃, CF₃CF₂CH₂OCOOCH₃, CF₃CH₂OCOOCH₂CH₃ or a combination thereof.

The fluorine-containing ester solvent may include, for example, a compound represented by Formula C.

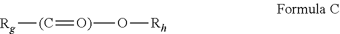

In Formula C, R_{g} and Rₕ are independently a C2-C10 alkyl group or a fluorine-containing C2-C10 alkyl group, provided that at least one of R_{g} and Rₕ is a fluorine-containing alkyl group. In the fluorine-containing alkyl group, one or more, or all, of the hydrogen atoms of the alkyl group may be substituted with fluorine atoms.

The fluorine-containing solvent may include, for example, CF₃C(═O)OCH₂CF₃, CF₃C(═O)OCH₂CF₂CF₃, CF₃C(═O)OCH₂CF₂CF₂H, HCF₂C(═O)OCH₂CF₃, HCF₂C(═O)OCH₂CF₂CF₃, HCF₂C(═O)OCF₂CF₂H, CF₃C(═O)OCH₃, CF₃C(═O)OCH₂CH₃, HCF₂C(═O)OCH₃, HCF₂C(═O)OCH₂CH₃, CH₃CF₂C(═O)OCH₃, CH₃CF₂C(═O)OCH₂CH₃, CF₃CF₂C(═O)OCH₃, CF₃CF₂C(═O)OCH₂CH₃, CH₃C(═O)OCH₂CF₃, CH₃C(═O)OCH₂CF₂CF₃, CH₃C(═O)OCH₂CF₂CF₂H, CH₃CH₂C(═O)OCH₂CF₃, CH₃CH₂C(═O)OCH₂CF₂CF₃, CH₃CH₂C(═O)OCH₂CF₂CF₂H or a combination thereof.

The fluorine-containing ether solvent may include, for example, a compound represented by Formula D or Formula E.

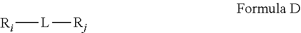

In Formula D, Rᵢ and Rⱼ are each independently a C₁-C₁₀ alkyl group or a fluorine-containing C₁-C₁₀ alkyl group,
provided that at least one of Rᵢ and Rⱼ is a fluorine-containing alkyl group. In the fluorine-containing alkyl group, one or more or all of the hydrogen atoms of the alkyl group may be substituted with fluorine atoms.

The fluorine-containing solvent may include, for example, HCF₂CF₂CH₂OCF₂CF₂H, CF₃CF₂CH₂OCF₂CF₂H, HCF₂CF₂CH₂OCF₂CFHCF₃, CF₃CF₂CH₂OCF₂CFHCF₃, HCF₂CF₂CH₂OCH₂CFHCF₃, CF₃CF₂CH₂OCH₂CFHCF₃ or a combination thereof.

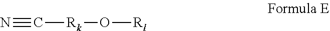

In Formula E, Rₖ is a C₁-C₁₀ alkylene group or a fluorine-containing C₁-C₁₀ alkylene group, and,

R₁ is a C₁-C₁₀ alkyl group or a fluorine-containing C₁-C₁₀ alkyl group, provided that at least one of Rₖ and Rₗ contains fluorine. In the fluorine-containing alkyl group and fluorine-containing alkylene group, one or more or all of the hydrogen atoms of the alkyl or alkylene group may be substituted with fluorine atoms.

The fluorine-containing solvent may include, for example, 3-(2,2,3,3-tetrafluoropropoxy)propanenitrile, 3-(2,2,3,3,3-pentafluoropropoxy)propanenitrile, 3-(3,3,3-trifluoropropoxy)propanenitrile, 3-(2,2,3-trifluoropropoxy)propanenitrile, 3-(2,3,3 -trifluoropropoxy)propanenitrile, 3-(3,3-difluoropropoxy)propanenitrile, 3-(2,2-difluoropropoxy)propanenitrile, or a combination thereof.

By including a fluorine-containing solvent in the cathode electrolyte, the viscosity of the cathode electrolyte may be reduced. As the viscosity of the cathode electrolyte decreases, the cathode electrolyte may more easily infiltrate the cathode active material layer and may provide improved ionic conductivity. The viscosity of the fluorine-containing solvent may be 95% or less, 90% or less, 85% or less, or 80% or less of the viscosity of the ionic liquid.

The cathode electrolyte may further include, for example, a polymer binder, an oligomeric binder, or the like. The cathode electrolyte may further include, for example, an oligomer having a molecular weight of 1000 daltons or more, a polymer having a molecular weight of 1000 daltons or more, or a combination thereof. By further including a polymer, an oligomer, or the like used as a binder in the cathode electrolyte, the structural stability of the cathode may be improved.

The cathode electrolyte may further include, for example, a non-aqueous solvent. The cathode electrolyte may further include a non-aqueous solvent, such as hydrocarbon-based solvents, ether-based solvents, or carbonate-based solvents. By further including a non-aqueous solvent in the cathode electrolyte, the viscosity of the cathode electrolyte may be easily controlled.

The cathode electrolyte may further include, for example, an inorganic solid electrolyte. The cathode electrolyte may further include an inorganic solid electrolyte in addition to the above-described organic electrolyte. The cathode electrolyte may include, for example, an inorganic solid electrolyte such as a sulfide-based solid electrolyte, an oxide-based solid electrolyte, or a halide-based solid electrolyte. By further including an inorganic solid electrolyte in the cathode electrolyte, the structural stability of the cathode may be improved.

The cathode active material 110 may be any material commonly used in lithium batteries without limitation. For example, it may be a lithium transition metal oxide or a transition metal sulfide. For example, one or more composite oxide of lithium and a metal such as cobalt, manganese, nickel, or a combination thereof may be used, and specific examples thereof include one or more compounds represented by the following Formulae: LiₐA_{1-b}B_{b}D₂ (where 0.90≤a≤1.8, and 0≤b≤0.5); LiₐE_{1-b}B_{b}O_{2-c}D_{c} (where 0.90≤a≤1.8, 0≤b≤0.5, 0≤c≤0.05); LiE_{2-b}B_{b}O_{4-c}D_{c} (where 0≤b≤0.5, 0≤c≤0.05); LiₐNi_{1-b-c}Co_{b}B_{c}D_{α} (where 0.90≤a≤1.8, 0≤b≤0.5, 0≤c≤0.05, 0<α≤2); LiₐNi_{1-b-c}Co_{b}B_{c}O_{2-α}F_{α} (where 0.90≤a≤1.8, 0≤b≤0.5, 0<<<0.05, 0<α<2); LiₐNi_{1-b-c}Co_{b}B_{c}O_{2-α}F₂ (where 0.90≤a≤1.8, 0≤b≤0.5, 0≤c≤0.05, 0<α<2); LiₐNi_{1-b-c}Mn_{b}B_{c}D_{α} (where 0.90≤a≤1.8, 0≤b≤0.5, 0≤c≤0.05, 0<α≤2); LiₐNi_{1-b-c}Mn_{b}B_{c}O_{2-α}F_{α} (where 0.90≤a≤1.8, 0≤b≤0.5, 0≤c≤0.05, 0<α<2); LiₐNi_{1-b-c}Mn_{b}B_{c}O_{2-α}F₂ (where 0.90≤a≤1.8, 0≤b≤0.5, 0≤c≤0.05, 0<α<2); LiₐNi_{b}E_{c}G_{d}O₂ (where 0.90≤a≤1.8, 0≤b≤0.9, 0≤c≤0.5, 0.001≤d≤0.1); LiₐNi_{b}Co_{c}Mn_{d}GeO₂ (where 0.90≤a≤1.8, 0≤b≤0.9, 0≤c≤0.5, 0≤d≤0.5, 0.001≤e≤0.1); LiₐNiG_{b}O₂ (where 0.90≤a≤1.8, 0.001≤b≤0.1); LiₐCoG_{b}O₂ (where 0.90≤a≤1.8, 0.001≤b≤0.1); LiₐMnG_{b}O₂ (where 0.90≤a≤1.8, 0.001≤b≤0.1); LiₐMn₂G_{b}O₄ (where 0.90≤a≤1.8, 0.001≤b≤0.1); QO₂; QS₂; LiQS₂; V₂O₅; LiV₂O₂; LiIO₂; LiNiVO₄; Li_{(3-f)}J₂(PO₄)₃ (0≤f≤2); Li_{(3-f)}Fe₂(PO₄)₃ (0≤f≤2); LiFePO₄. In the above Formulae, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof. Examples include LiCoO₂, LiMnₓO₂ₓ (x=1, 2), LiNi₁₋ₓMnₓO₂ₓ (0<x<1), Ni_{1-x-y}CoₓMn_{y}O₂ (0≤x≤0.5, 0≤y≤0.5), LiFePO₄, TiS₂, FeS₂, TiS₃, FeS₃.

The cathode active material 110 may be, for example, one or more of compounds represented by Formulae 10 to 17.

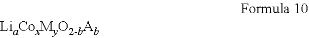

In Formula 10,
1.0≤a≤1.2, 0≤b≤0.2, 0.9≤x≤1, 0≤y≤0.1, and x+y=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br, or a combination thereof,

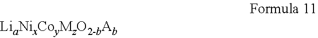

In Formula 11,
1.0≤a≤1.2, 0≤b≤0.2, 0.8≤x<1, 0≤y≤0.3, 0<z≤0.3, and x+y+z=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br, or a combination thereof,

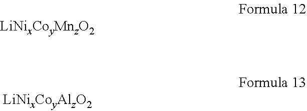

In Formulae 12 to 13, 0.8≤x≤0.95, 0≤y≤0.2, 0<z≤0.2 and x+y+z=1,

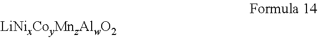

In Formula 14, 0.8≤x≤0.95, 0≤y≤0.2, 0<z≤0.2, 0<w≤0.2, and x+y+z+w=1,

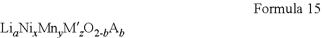

In Formula 15,
1.0≤a≤1.2, 0≤b≤0.2, 0<x≤0.3, 0.5≤y<1, 0<z≤0.3, and x+y+z=1,
M′ is cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof,
A is F, S, Cl, Br, or a combination thereof,

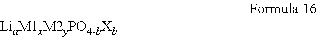

In Formula 16, 0.90≤a≤1.1, 0≤x≤0.9, 0≤y≤0.5, 0.9<x+y<1.1, 0≤b≤2,
M1 is chromium (Cr), manganese (Mn), iron (Fe), cobalt (Co), nickel (Ni), copper (Cu), zirconium (Zr), or a combination thereof,
M2 is magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y) or a combination thereof, and X is O, F, S, P or a combination thereof.

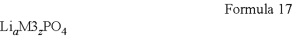

In Formula 17, 0.90≤a≤1.1, 0.9≤z≤1.1, and
M3 is chromium (Cr), manganese (Mn), iron (Fe), cobalt (Co), nickel (Ni), copper (Cu), zirconium (Zr), or a combination thereof.

The cathode mixture 100 may further include a conductive material and a binder.

The conductive material may include, for example, carbon black, carbon fiber, graphite, or a combination thereof. Carbon black may be, for example, acetylene black, Ketjen black, Super P carbon, channel black, furnace black, lamp black, thermal black or a combination thereof. Graphite may be natural or artificial graphite. A combination including at least one of the foregoing may be used. The cathode may further include an additional conductive materials other than the carbon-based conductive material described above. The additional conductive material may be electrically conductive fibers such as metal fibers; metal powders such as fluorinated carbon powder, aluminum powder, or nickel powder; conductive whiskers such as zinc oxide or potassium titanate; or polyethylene derivatives. A combination including at least one of the aforementioned conductive materials may be used in combination with another conductive material. The content of the conductive material may be about 1 part to about 10 parts by weight, or about 2 parts to about 7 parts by weight, based on 100 parts by weight of the cathode active material. When the content of the conductive material is within this range, for example, about 1 part to about 10 parts by weight, the electrical conductivity of the cathode may be appropriate.

The binder may improve the adhesion between components of the cathode as well as the adhesion of the cathode to the current collector. Examples of the binder include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene rubber, fluorinated rubber, copolymers thereof, or a combination thereof. The content of the binder may be about 1 part to about 10 parts by weight, or about 2 parts to about 7 parts by weight, based on 100 parts by weight of the cathode active material. When the content of the binder is within this range, the adhesion of the cathode active material layer to the cathode current collector may be further improved while suppressing a reduction in the energy density of the cathode active material layer.

### Secondary Battery

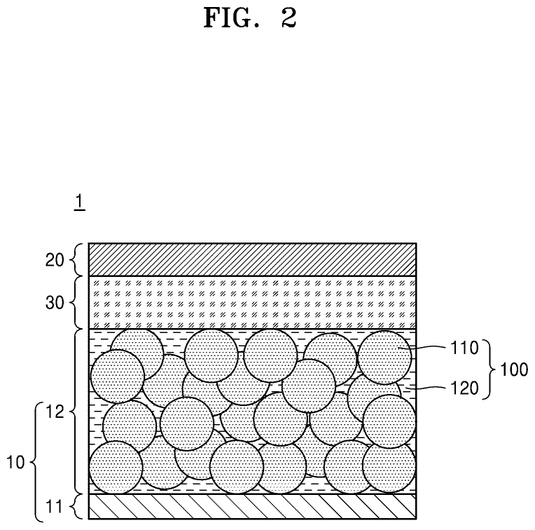

FIGS. 2 to 4 are schematic illustrations of the structure of a secondary battery according to an embodiment.

Referring to FIGS. 2 to 4, a secondary battery 1 according to another embodiment includes a cathode 10 including the above-described cathode mixture 100, an anode 20, and a solid electrolyte layer 30 disposed between the cathode 10 and the anode 20. When the secondary battery 1 includes the above-described cathode mixture 100, the elution of the transition metal included in the cathode active material 110 in the cathode mixture 100 is reduced, thereby preventing a decrease in charge/discharge performance due to the eluted transition metal. Accordingly, the secondary battery 1 including the above-described cathode mixture 100 has improved charge/discharge characteristics.

The secondary battery 1 may be, for example, an all-solid secondary battery, a semi-solid secondary battery, a hybrid secondary battery, or the like, but is not limited thereto, and any battery that may be used as a secondary battery 1, 1a in the relevant technical field may be used. In all-solid-state secondary batteries, the electrolyte may be is in solid form. In semi-solid secondary batteries, the electrolyte may be a gel. In a hybrid secondary battery, the electrolyte is a combination of multiple electrolytes in different states (for example, a combination of a solid electrolyte and a liquid electrolyte). The secondary battery 1, 1a may be, for example, an alkali metal secondary battery. The secondary battery 1, 1a may be, for example, a lithium secondary battery.

### Cathode

Referring to FIGS. 2 to 4, the cathode 10 includes a cathode current collector 11 and a cathode active material layer 12 disposed between the cathode current collector 11 and the solid electrolyte layer 30, and the cathode active material layer 12 includes the above-described cathode mixture 100.

### Cathode: Cathode Active Material Layer

The cathode active material layer 12 includes a cathode mixture 100. For a description of the cathode mixture 100, reference is made to the description described above.

### Cathode: Cathode Current Collector

The cathode 10 includes a cathode current collector 11. The cathode current collector 11 may be omitted.

The cathode current collector 11 may include, for example, a metal substrate. Examples of the metal substrate include a plate or foil made of aluminum (Al), indium (In), copper (Cu), magnesium (Mg), stainless steel, titanium (Ti), iron (Fe), cobalt (Co), nickel (Ni), zinc (Zn), germanium (Ge), lithium (Li), or an alloy thereof. The cathode current collector may be omitted. The cathode current collector may further include a carbon layer (not shown) disposed on one or both sides of the metal substrate. By additionally disposing a carbon layer on the metal substrate, corrosion of the metal in the metal substrate by the solid electrolyte contained in the cathode layer may be prevented, and the interfacial resistance between the cathode active material layer and the cathode current collector may be reduced. The thickness of the carbon layer may be, for example, about 0.1 μm to about 5 μm, about 0.1 μm to about 3 μm, or about 0.1 μm to about 1 μm. If the carbon layer is too thin, it may be difficult to completely block contact between the metal substrate and the solid electrolyte. If the carbon layer is too thick, the energy density of the all-solid-state secondary battery may decrease. The carbon layer may include amorphous carbon, crystalline carbon, or the like.

### Liquid Electrolyte

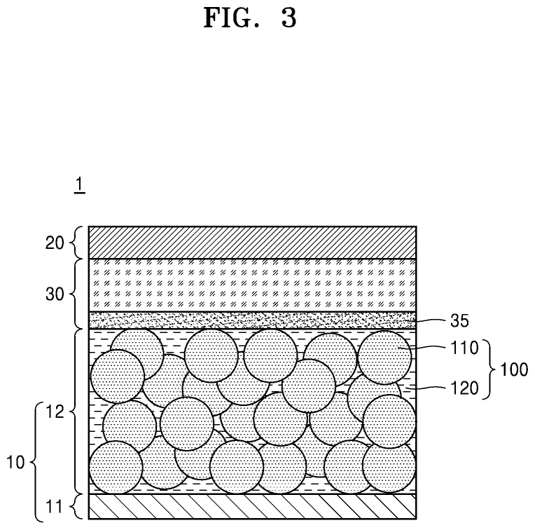

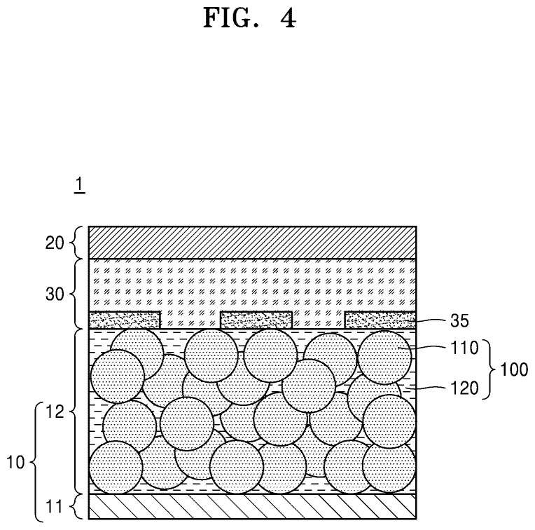

Referring to FIGS. 3 and 4, the secondary battery 1 further includes a liquid electrolyte 35 disposed between the cathode active material layer 110 and the solid electrolyte layer 30, and the liquid electrolyte includes a flame retardant liquid, and an ionic liquid, and the flame retardant liquid includes a compound represented by Formula 1 described above.

The liquid electrolyte 35 includes a flame retardant liquid and an ionic liquid. For a description of the flame retardant liquid and the ionic liquid, reference is made to the above-mentioned descriptions.

The liquid electrolyte 35 may correspond to the above-described cathode electrolyte. The liquid electrolyte 35 may be formed when some of the cathode electrolyte 120 included in the cathode mixture 100 is placed between the cathode active material layer 110 and the solid electrolyte layer 30.

For example, as the liquid electrolyte 35 flows into an area where the surface of the cathode active material layer 110 and the surface of the solid electrolyte layer 30 are not in complete contact with each other but are separated from each other, the liquid electrolyte 35 may be formed between the cathode active material layer 110 and the solid electrolyte layer 30.

Referring to FIG. 3, the liquid electrolyte 35 may completely cover the surface of the solid electrolyte layer 30. Referring to FIG. 4, the liquid electrolyte 35 is disposed between the cathode active material layer 110 and the solid electrolyte layer 30, and may be disposed on at least a portion of the surface of the solid electrolyte layer 30.

### Solid Electrolyte Layer

Referring to FIGS. 2 to 4, the lithium battery 1 includes a solid electrolyte layer 30, and the solid electrolyte layer 30 is disposed between the cathode 10 and the anode 20.

The solid electrolyte layer 30 may be, for example, liquid impermeable. Therefore, the cathode electrolyte 100 cannot penetrate the solid electrolyte layer 30.

The solid electrolyte layer 30 may include, for example, an oxide-based solid electrolyte, a sulfide-based solid electrolyte, a halide-based solid electrolyte, or a combination thereof. The solid electrolyte layer 30 may have, for example, a single-layer structure or a multi-layer structure. One or more solid electrolytes selected from the oxide-based solid electrolyte, sulfide-based solid electrolyte, and halide-based solid electrolyte described above may be placed in one layer or multiple layers constituting the solid electrolyte layer 30.

According to an embodiment, the solid electrolyte layer 30 includes an oxide-based solid electrolyte, and the oxide-based solid electrolyte may include, for example, lithium phosphorus oxynitride (LiPON), Li₃ₓLa_{(2/3-x)(1/3-2x)}TiO₃ (0.04<x<0.16), Li₁₊ₓAlₓTi₂₋ₓ(PO₄)₃ (0<x<2), Li₁₊ₓAlₓGe₂₋ₓ(PO₄)₃ (0<x<2), Li_{1+x+y}AlₓTi₂₋ₓSi_{y}P_{3-y}O₁₂ (0<x<2, 0≤y<3), BaTiO₃, Pb(Zr, Ti)O₃, Pb₁₋ₓLaₓZr_{1-y}Ti_{y}O₃ (0≤x<1, 0≤y<1), Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(Al, Ga)ₓ(Ti, Ge)₂₋ₓSi_{y}P_{3-y}O₁₂ (0≤x≤1 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M is Te, Nb, or Zr, 1≤x≤10), Li₇La₃Zr₂O₁₂, Li₃₊ₓLa₃Zr₂₋ₐMₐO₁₂, (M is Ga, W, Nb, Ta, or Al, 0<a<2, 1≤x≤10), or a combination thereof. However, the oxide-based solid electrolyte is not limited to these examples and may include any material commonly used in the art as an oxide-based solid electrolyte. The solid electrolytes may be produced, for example, by sintering methods. The oxide-based solid electrolytes may be, for example, a garnet-type solid electrolyte selected from Li₇La₃Zr₂O₁₂ (LLZO) and Li₃₊ₓLa₃Zr₂₋ₐMₐO₁₂ (M doped LLZO, M=Ga, W, Nb, Ta, or Al, 0<a<2, 1≤x≤10).

The oxide-based solid electrolyte may be, for example, crystalline, amorphous, glassy or glass-ceramic. The oxide-based solid electrolytes may have various crystal states depending on the preparation method and composition.

The sulfide-based solid electrolyte may include, for example, lithium sulfide, silicon sulfide, phosphorus sulfide, boron sulfide, or a combination thereof. The sulfide-based solid electrolyte particles may include Li₂S, P₂S₅, SiS₂, GeS₂, B₂S₃ or a combination thereof. The sulfide-based solid electrolyte particles may be Li₂S or P₂S₅. Sulfide-based solid electrolyte particles are known to have high lithium ion conductivity compared to other inorganic compounds. For example, the sulfide-based solid electrolyte may include Li₂S and P₂S₅. When the sulfide solid electrolyte material constituting the solid electrolyte includes Li₂S—P₂S₅, the molar mixing ratio of Li₂S to P₂S₅ may range from about 50:50 to about 90:10. The sulfide-based solid electrolyte may also include an inorganic solid electrolyte prepared by adding Li₃PO₄, a halogen, a halogen compound, Li₂₊₂ₓZn₁₋ₓGeO₄ (“LISICON”), Li_{3+y}PO₄₋ₓNₓ (“LIPON”), Li_{3.25}Ge_{0.25}P_{0.75}S₄ (“Thio-LISICON”), Li₂O—Al₂O₃—TiO₂—P₂O₅ (“LATP”), and the like to an inorganic solid electrolyte of Li₂S—P₂S₅, SiS₂, GeS₂, B₂S₃, or a combination thereof. Non-limiting examples of the sulfide-based solid electrolyte materials include Li₂S—P₂S₅; Li₂S—P₂S₅—LiX (where X is a halogen element); Li₂S—P₂S₅—Li₂O; Li₂S—P₂S₅—Li₂O—LiI; Li₂S—SiS₂; Li₂S—SiS₂—LiI; Li₂S—SiS₂—LiBr; Li₂S—SiS₂—LiCl; Li₂S—SiS₂—B₂S₃—LiI; Li₂S—SiS₂—P₂S₅—LiI; Li₂S—B₂S₃; Li₂S—P₂S₅—ZₘSₙ (where m and n are positive numbers, and Z is Ge, Zn, or G); Li₂S—GeS₂; Li₂S—SiS₂—Li₃PO₄; and Li₂S—SiS₂-LiₚMO_{q} (where p and q are positive numbers, and Mis P, Si, Ge, B, Al, Ga or In). In this regard, the sulfide-based solid electrolyte material may be produced by processing precursor raw materials (e.g., Li₂S, P₂S₅, etc.) of the sulfide-based solid electrolyte using methods such as melt quenching or mechanical milling. Additionally, a calcination process may be performed after such treatment.

The halide-based solid electrolyte may include, for example, a halogen element as the main component of the anions. The inclusion of a halogen element as the main component of the anions means that, among all the anions constituting the halide-based solid electrolyte, the halogen element has the highest molar ratio. The molar ratio of the halogen (X) element among all the anions constituting the halide-based solid electrolyte may be, for example, 50 mol % or more, 70 mol % or more, 90 mol % or more, or even 100 mol %. The halogen element may include one or more types. The halide-based solid electrolyte may not contain, for example, sulfur element (S element). The halide-based solid electrolyte may contain lithium (Li), a metal element M (other than Li), and a halogen element X. X may be, for example, F, Cl, Br, I, or a combination thereof. The halide-based solid electrolyte may include Br or Cl as the halogen X. As for the metal element M, the halide-based solid electrolyte may include, for example, Sc, Y, B, Al, Ga, In or the like. The composition of the halide-based solid electrolyte may be represented by, for example, Li₆₋₃ₐMₐBr_{b}Cl_{c} (where M is a metal other than Li, 0<a<2, 0≤b≤6, 0≤c≤6, and b+c=6). The halide solid electrolyte may be, for example, Li₃YBr₆, Li₃YCl₆, Li₃YBr₂Cl₄, or the like. The halide solid electrolyte may be, for example, in the form of particles. The average particle diameter (D50) of the halide-based solid electrolyte may be, for example, from about 0.05 μm to about 50 μm, or from about 0.1 μm to about 20 μm. The average particle diameter (D₅₀) may be measured using, for example, a laser diffraction particle size analyzer or a scanning electron microscope (SEM).

The thickness of the solid electrolyte layer 30 may be, for example, 500 μm or less, 300 μm or less, 100 μm or less, or 50 μm or less. The thickness of the solid electrolyte layer 30 may be from about 1 μm to about 500 μm, about 5 μm to about 300 μm, about 10 μm to about 100 μm, or about 10 μm to about 50 μm.

Alternatively, the solid electrolyte layer 30 may be formed by mixing the above-described solid electrolyte with other components. The solid electrolyte layer 30 be produced by mixing and drying the above-described solid electrolyte with a binder, or by pressing and/or sintering the solid electrolyte powder into a specific form. The solid electrolyte layer 30 may be formed by mixing and drying a sulfide-based, oxide-based, and/or halide-based solid electrolyte with a binder, or by pressing and/or sintering the sulfide-based, oxide-based, and/or halide-based solid electrolyte powder into a predetermined form.

The solid electrolyte layer 30 may be deposited on the cathode 10 or the anode 20 using a film-forming method such as blasting, aerosol deposition, cold spraying, sputtering, chemical vapor deposition (CVD), or spraying. In this manner, the solid electrolyte layer may be prepared. The solid electrolyte layer 30 may also be formed, for example, by pressing the solid electrolyte. The solid electrolyte layer 30 may be formed by mixing and pressurizing a solid electrolyte, a solvent, and a binder or support. In this case, a solvent or support is added to reinforce the strength of the solid electrolyte layer or to prevent short-circuits of the solid electrolyte.

The binder included in the solid electrolyte layer 30 may be, for example, styrene butadiene rubber (SBR), polytetrafluoroethylene, polyvinylidene fluoride, polyethylene, polyvinyl alcohol, or the like, but is not limited thereto, and any binder used in the relevant technical field may be used. The binder of the solid electrolyte layer 30 may be the same as or different from the binder of the cathode and/or anode.

According to an embodiment, in XPS depth profile analysis of the surface of the solid electrolyte layer 30 adjacent to the cathode active material layer 12, a peak of a transition metal derived from the cathode active material may be absent (free). For example, the cathode active material layer 12 may include the above-described cathode mixture, and the cathode mixture may include the above-described cathode active material and a flame retardant liquid. The flame retardant liquid prevents the elution of the transition metal included in the cathode active material, so that the surface of the solid electrolyte layer 30 adjacent to the cathode active material layer 12 may be free of the transition metal. Accordingly, in the XPS depth profile analysis of the surface of the solid electrolyte layer 30 adjacent to the cathode active material layer 12, the peak of the transition metal derived from the positive electrode active material may be absent (free).

### Anode: Anode Active Material Layer

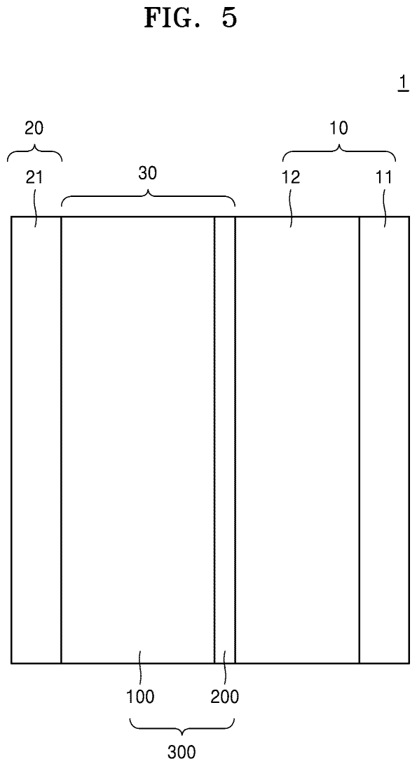

Referring to FIGS. 5 to 8, the secondary battery 1, 1a includes an anode 20, and the anode 20 includes an anode current collector 21 or includes an anode current collector 21 and an anode active material layer 23.

The thickness of the anode 20 may be smaller than the thickness of the cathode 10. The thickness of the anode 20 may be, for example, 90% or less, 80% or less, 60% or less, or 50% or less of the thickness of the cathode 10.

The anode active material layer 23 may include, for example, lithium foil, lithium powder, plated lithium, a lithium alloy, or a combination thereof. The anode active material layer 23 may be, for example, a lithium metal layer. The anode active material layer 23 may be prepared by applying a slurry containing lithium powder and a binder or the like onto the anode current collector 21. The binder may be a fluorine-based binder, such as polyvinylidene fluoride (PVDF). The anode active material layer 23 may not include a carbon-based anode active material. The anode active material layer 23 may be made of a metal-based anode active material. The anode active material layer 23 may also be a plated lithium metal layer. The lithium alloy may include, but is not limited to, a Li—Al alloy, a Li—Sn alloy, a Li—In alloy, a Li—Ag alloy, a Li—Au alloy, a Li—Zn alloy, a Li—Ge alloy, a Li—Si alloy, or the like, and any lithium alloy used in the relevant technical field may be used.

The thickness of the anode active material layer 23 may be, for example, from about 0.1 μm to about 100 μm, from about 0.1 μm to about 80 μm, from about 1 μm to about 80 μm, or from about 10 μm to about 80 μm. However, it is not limited to these ranges and may be adjusted depending on the type and capacity requirements of the secondary battery. If the thickness of the anode active material layer 23 is excessively large, the structural stability of the secondary battery may deteriorate and side reactions may increase. If the thickness of the negative electrode active material layer 23 is too small, the energy density of the secondary battery may decrease. The thickness of the lithium foil may be, for example, about 1 μm to about 50 μm, about 1 μm to about 30 μm, or about 10 μm to about 30 μm, or about 10 μm to about 80 μm. When the lithium foil has a thickness within these ranges, the cycle life characteristics of a secondary battery including a protective layer may be further improved. The particle size of lithium powder may be, for example, from about 0.1 μm to about 3 μm, from about 0.1 μm to about 2 μm, or from about 0.1 μm to about 1 μm. When the lithium powder has a particle size within these ranges, the cycle life characteristics of a lithium battery including a protective layer may be further improved. The thickness of the lithium plating layer may be, for example, from about 1 μm to about 80 μm, or from about 10 μm to about 80 μm.

### Anode: Anode Current Collector

The anode 20 includes an anode current collector 21.

The anode current collector 21 may include, for example, a first metal substrate. The first metal substrate may include a first metal as a main component or be composed of the first metal. The content of the first metal in the first metal substrate may be, for example, 90 wt % or more, 95 wt % or more, 99 wt % or more, or 99.9 wt % or more based on the total weight of the substrate. The first metal substrate may be composed of a material that does not react with lithium, i.e., does not form an alloy and/or compound with lithium. The first metal may include, for example, copper (Cu), nickel (Ni), stainless steel (SUS), iron (Fe), cobalt (Co), or the like, but is not limited thereto. Any material commonly used as a current collector in the art may be used. The first metal substrate may be composed of one of the metals listed above or an alloy of two or more of these metals. The first metal substrate may be in the form of a sheet or a foil. The thickness of the anode current collector 21 may be, for example, from about 5 μm to about 50 μm, from about 10 μm to about 50 μm, from about 10 μm to about 40 μm, or from about 10 μm to about 30 μm, but is not limited to these ranges and may be selected according to the required properties of the lithium battery.

The anode current collector 21 may further include a coating layer (not shown) containing a second metal formed on the first metal substrate.

The anode current collector 21 may include the first metal substrate and a coating layer containing the second metal disposed on the first metal substrate. The second metal has a higher Mohs hardness than the first metal. That is, since the coating layer containing the second metal is harder than the first metal substrate, it may prevent degradation of the first metal substrate. The Mohs hardness of the material constituting the first metal substrate may be, for example, 5.5 or less. The Mohs hardness of the first metal may be 5.5 or less, 5.0 or less, 4.5 or less, 4.0 or less, 3.5 or less, or 3.0 or less. The Mohs hardness of the first metal may be, for example, from about 2.0 to about 6.0. The coating layer contains the second metal. The coating layer may include, for example, the second metal as a main component or be composed of the second metal. The content of the second metal in the coating layer may be, for example, 90 wt % or more, 95 wt % or more, 99 wt % or more, or 99.9 wt % or more, based on the total weight of the coating layer. The coating layer may be composed of a material that does not react with lithium, i.e., does not form an alloy and/or compound with lithium. The Mohs hardness of the material constituting the coating layer may be, for example, 6.0 or higher. For example, the Mohs hardness of the second metal may be 6.0 or greater, 6.5 or greater, 7.0 or greater, 7.5 or greater, 8.0 or greater, 8.5 or greater, or 9.0 or greater. The Mohs hardness of the second metal may be, for example, about 6.0 to about 12. If the Mohs hardness of the second metal is too low, it may be difficult to suppress deterioration of the anode current collector. If the Mohs hardness of the second metal is too high, it may not be easy to process. The second metal may include one or more of titanium (Ti), manganese (Mn), niobium (Nb), tantalum (Ta), iridium (Ir), vanadium (V), rhenium (Re), osmium (Os), tungsten (W), chromium (Cr), boron (B), ruthenium (Ru), and rhodium (Rh). The coating layer may be composed of one of these metals, or an alloy of two or more of them. The difference in Mohs hardness between the first metal included in the first metal substrate and the second metal included in the coating layer may be, for example, 2 or more, 2.5 or more, 3 or more, 3.5 or more, or 4 or more. By having such a difference in Mohs hardness between the first metal and the second metal, degradation of the anode current collector may be more effectively suppressed. The coating layer may be a single-layer structure or a multilayer structure including two or more layers. For example, the coating layer may have a two-layer structure including a first coating layer and a second coating layer. Alternatively, the coating layer may have a three-layer structure including a first coating layer, a second coating layer, and a third coating layer. The thickness of the coating layer may be, for example, from about 10 nm to about 1 μm, from about 50 nm to about 500 nm, from about 50 nm to about 200 nm, or from about 50 nm to about 150 nm. If the thickness of the coating layer is too thin, it may be difficult to suppress the non-uniform growth of the lithium-containing metal layer. As the thickness of the coating layer increases, the cycle characteristics of the lithium battery may be improved. However, if the thickness of the coating layer is too thick, the energy density of the lithium battery may be decreased and the formation of the coating layer may not be easy. The coating layer may be formed on the first metal substrate by vacuum deposition, sputtering, electroplating, or other methods. However, the coating method is not limited to these examples, and any method known in the art for forming a coating layer may be used.

### Anode: First Intermediate Layer

Although not shown in FIGS. 5 to 8, the anode 20 may further include a first intermediate layer (not shown) disposed between the anode current collector 21 and the solid electrolyte layer 30. By including the first intermediate layer in the anode 20, the formation and/or growth of lithium dendrites in the anode 20 may be more effectively suppressed. The first intermediate layer (not shown) may be omitted. The thickness of the first intermediate layer may be smaller than that of the solid electrolyte layer 30 or the cathode 10.

The first intermediate layer (not shown) may include, for example, an anolyte.

The anolyte may be an organic electrolyte solution. The organic electrolyte solution may be prepared by dissolving a lithium salt in an organic solvent.

Any organic solvent commonly used in the art may be employed. Examples of the organic solvent include propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether or mixtures thereof.

Any lithium salt that is used as a lithium salt in the relevant technical field is also possible. Examples of the lithium salt include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LoN (CₓF₂ₓ₊₁SO₂) (C_{y}F_{2y+1}SO₂) (1≤x≤20, 1≤y≤20), LiCl, LiI or a mixture thereof. The concentration of lithium salt may be, for example, about 0.1 M to about 5.0 M.

The first intermediate layer (not shown) may also include a separator and an anolyte impregnated into the separator.

Any separator commonly used in lithium batteries may be employed. The separator may be selected, for example, to have low resistance to ion transport in the electrolyte while exhibiting excellent electrolyte absorption capability. The separator may be, for example, glass fiber, polyester, polyethylene, polypropylene, polytetrafluoroethylene (PTFE, available under the trade name TEFLON) or a combination thereof, and may be in the form of a nonwoven or woven fabric. In lithium-ion batteries, a windable separator such as polyethylene or polypropylene is typically used. In lithium-ion polymer batteries, separators with excellent organic electrolyte absorption capability are preferred.

The separator may be produced by the following exemplary methods, although it is not limited thereto and may be adjusted according to required conditions.

First, a separator composition is prepared by mixing a polymer resin, a filler, and a solvent. The separator composition may then be directly applied and dried on the surface of the electrode to form the separator. Alternatively, the separator composition may be cast and dried on a support, after which the resulting separator film is peeled from the support and laminated onto the electrode surface to form the separator.

The polymer used for preparing the separator is not particularly limited and may be any polymer commonly used as a binder in electrode plates. Examples include vinylidene fluoride/hexafluoropropylene copolymer, polyvinylidene fluoride (PVDF), polyacrylonitrile, polymethyl methacrylate, or mixtures thereof.

### Anode: Second Intermediate Layer

Alternatively, referring to FIGS. 5 to 8, the anode 20 may further include a second intermediate layer 22 disposed between the anode current collector 21 and the solid electrolyte layer 30.

The second intermediate layer 22 may include, for example, a carbon-based material, a metal-based material, or a combination thereof; and a binder. The second intermediate layer 22 may be free of an organic electrolyte solution.

The carbon-based material and metal-based material may be, for example, materials capable of undergoing lithiation and delithiation. The carbon-based material and metal-based material included in the intermediate layer be, for example, in a particle form. The average particle diameter of the carbon-based and/or metal-based materials may be, for example, from about 10 nm to about 4 μm, from about 10 nm to about 1 μm, from about 10 nm to about 500 nm, from about 10 nm to about 100 nm, or from about 20 nm to about 80 nm. When the carbon-based and/or metal-based material has an average particle diameter within these ranges, the reversible plating and/or dissolution of lithium during charging and discharging can be facilitated. The average particle diameter of the carbon-based and/or metal-based materials may be, for example, the median diameter (D50) measured using a laser diffraction particle size analyzer.

The second intermediate layer 22 may include one or more of carbon-based materials and metal-based materials. The carbon-based material may be, for example, amorphous carbon. Examples of carbon-based materials include, but are not limited to, carbon black (CB), acetylene black (AB), furnace black (FB), ketjen black (KB), and graphene. Any material classified as amorphous carbon in the relevant technical field may be used. Amorphous carbon refer to carbon that has no crystallinity or very low crystallinity, and is distinguished from crystalline carbon or graphitic carbon. The metal-based material may be a metallic material or a metalloid material. The metal-based material may include, for example, one or more of gold (Au), platinum (Pt), palladium (Pd), silicon (Si), silver (Ag), aluminum (Al), bismuth (Bi), tin (Sn), and zinc (Zn). For example, nickel (Ni) is not considered a metal-based material as used herein, as it does not form an alloy with lithium. The intermediate layer may include a single type of material selected from the above carbon-based and metal-based materials, or a mixture thereof. For example, the intermediate layer may include amorphous carbon. The intermediate layer may include a mixture of amorphous carbon and one or more selected from gold (Au), platinum (Pt), palladium (Pd), silicon (Si), silver (Ag), aluminum (Al), bismuth (Bi), tin (Sn), and zinc (Zn). The mixing ratio of the mixture may be, for example, a weight ratio of about 10:1 to about 1:2, about 10:1 to about 1:1, about 7:1 to about 1:1, about 5:1 to about 1:1, or about 4:1 to about 2:1. The intermediate layer may include a mixture of first particles composed of amorphous carbon and second particles composed of a metal or metalloid. Examples of the metal include gold (Au), platinum (Pt), palladium (Pd), silicon (Si), silver (Ag), aluminum (Al), bismuth (Bi), tin (Sn), and zinc (Zn). The content of the second particles is about 8 wt % to about 60 wt %, about 10 wt % to about 50 wt %, about 15 wt % to about 40 wt %, or about 20 wt % to about 30 wt % based on the total weight of the mixture. When the content of the second particles falls within these ranges, for example, the cycle characteristics of the lithium battery may be further improved.

The binder included in the second intermediate layer 22 may include, for example, styrene-butadiene rubber (SBR), polytetrafluoroethylene (PTFE), polyvinylidene fluoride, polyethylene, vinylidene fluoride/hexafluoropropylene copolymer, polyacrylonitrile, polymethyl methacrylate, or the like, but is not limited thereto and any binder used in the relevant technical field may be used. The binder may consist of a single binder or a combination of two or more different binders. If the second intermediate layer 22 does not include a binder, it may be easily separated from the solid electrolyte layer 30 or the anode active material layer 23. The content of the binder in the second intermediate layer 22 may be, for example, from about 1 wt % to about 20 wt % based on the total weight of the second intermediate layer 22.

The thickness of the second intermediate layer 22 may be, for example, about 1 μm to about 20 μm, about 1 μm to about 15 μm, or about 2 μm to about 10 μm, or about 3 μm to about 7 μm. The thickness of the second intermediate layer 22 may be, for example, about 1% to about 50%, about 1% to about 30%, about 1% to about 10%, or about 1% to about 5% of the thickness of the cathode active material layer 12. If the thickness of the second intermediate layer 22 is too thin, lithium dendrites formed between the second intermediate layer 22 and the anode current collector may collapse the second intermediate layer 22, making it difficult to improve the cycle characteristics of the secondary battery 1, 1a. If the thickness of the second intermediate layer 22 increases excessively, the energy density of the secondary battery 1, 1a may decrease and it may be difficult to improve the cycle characteristics. As the thickness of the second intermediate layer 22 decreases, for example, the charging capacity of the second intermediate layer 22 also decreases. The charge capacity of the second intermediate layer 22 may be, for example, about 0.1% to about 50%, about 1% to about 30%, about 1% to about 10%, about 1% to about 5%, or about 1% to about 2% of the charge capacity of the cathode 10. If the charge capacity of the second intermediate layer 22 is too small, lithium dendrites formed between the second intermediate layer 22 and the anode current collector 21 may collapse the second intermediate layer 22, making it difficult to improve the cycle characteristics of the secondary battery 1, 1a. If the charging capacity of the second intermediate layer 22 increases excessively, the energy density of the secondary battery 1, 1a using the anode 20 may be decreased and it may be difficult to improve the cycle characteristics. The charge capacity of the cathode active material layer 12 is obtained by multiplying the charge capacity density (mAh/g) of the cathode active material by the mass of the cathode active material in the cathode active material layer. When several types of cathode active materials are used, the charge capacity density×mass value is calculated for each cathode active material, and the sum of these values is the charge capacity of the cathode active material layer 12. The charging capacity of the second intermediate layer 22 is also calculated in the same way. That is, the charging capacity of the second intermediate layer 22 is obtained by multiplying the charging capacity density (mAh/g) of the carbon-based material and/or the metal-based material by the mass of the carbon-based material and/or the metal-based material in the second intermediate layer 22. When several types of carbon-based materials and/or metal-based materials are used, the charging capacity density×mass value is calculated for each material, and the sum of these values is the capacity of the second intermediate layer 22. Here, the charge capacity density of the cathode active material and the carbon-based material and/or the metal-based material is the capacity measured using an all-solid-state half-cell using lithium metal as a counter electrode. The charge capacity of the cathode active material layer 12 and the second intermediate layer 22 are directly measured by measuring the charge capacity using an all-solid-state half-cell. By dividing the measured charge capacity by the mass of each active material, the charge capacity density is obtained. Alternatively, the charge capacity of the cathode active material layer 12 and the second intermediate layer 22 may be the initial charge capacity measured during the first charge cycle.

### Anode: Introduction of Anode Active Material Layer

Referring to FIG. 5, after assembly of the secondary battery 1, 1a, the secondary battery 1, 1a includes a cathode 10, an anode 20, and a solid electrolyte layer 30, wherein the anode 20 includes an anode current collector 21 and the anode 20 may not include an anode active material layer 23. Referring to FIG. 5, after assembly of the secondary battery 1, 1a, the secondary battery 1, 1a includes a cathode 10, an anode 20, and a solid electrolyte layer 30, wherein the anode 20 may include an anode current collector 21 and an anode active material layer 23.

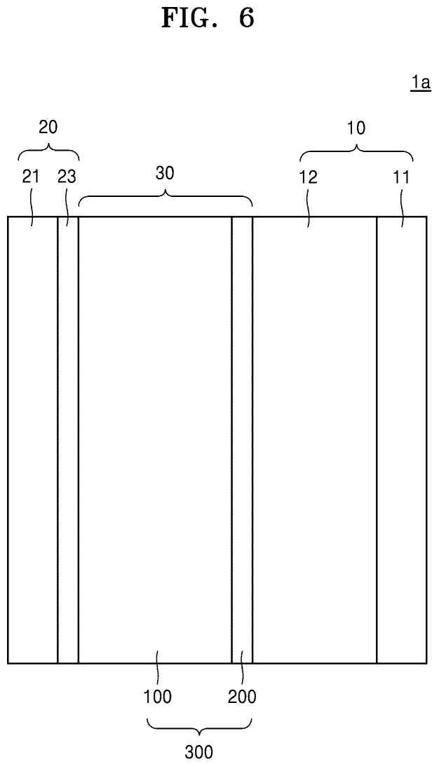

Referring to FIGS. 5 and 6, in a secondary battery 1a including an anode active material layer 23 formed by deposition during charging, the anode active material layer 23 is not included during assembly of the secondary battery 1, 1a, thereby increasing the energy density of the battery.

For example, when charging a secondary battery 1, lithium is deposited between the anode current collector 21 and the solid electrolyte layer 30, and an anode active material layer 23 is formed by the deposited lithium. The anode active material layer 23 is a metal layer mainly composed of lithium (i.e., metallic lithium). During discharge, lithium in the anode active material layer 23, i.e., the metal layer, is ionized and moves toward the cathode 10. In the secondary battery 1a, lithium may serve as the anode active material. In the secondary battery 1a including the anode active material layer 23 deposited by charging, the region between the anode current collector 21 and the solid electrolyte layer 30 is a Li-free region, for example, in the initial state or after discharge of the secondary battery 1, meaning that it does not contain lithium (Li).

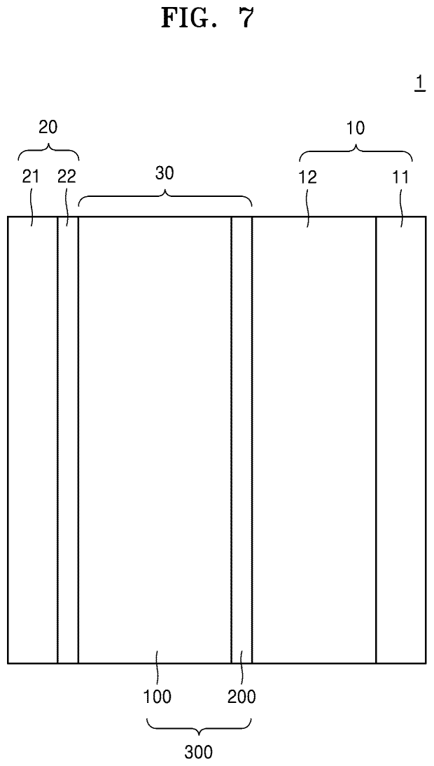

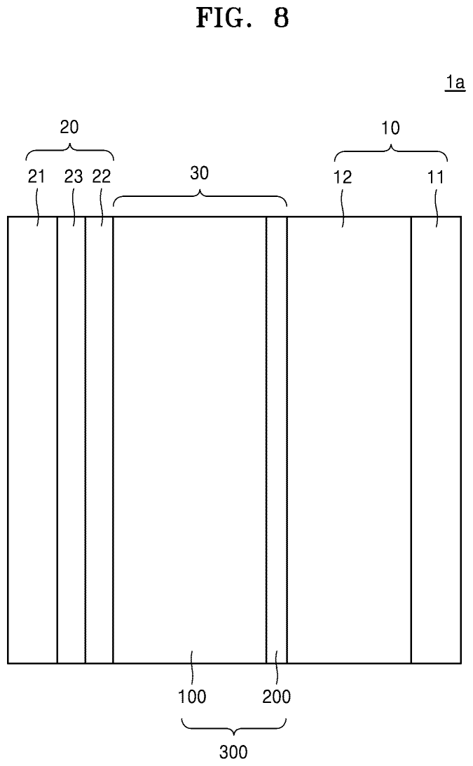

Referring to FIG. 7, after assembly of the secondary battery 1, 1a, the secondary battery 1, 1a includes the cathode 10, the anode 20, and the solid electrolyte layer 30, wherein the anode 20 includes the anode current collector 21 and a second intermediate layer 22, and may not include the anode active material layer 23. The second intermediate layer 22 may include, for example, a carbon-based material and/or a metal-based material. By charging the secondary battery 1 shown in FIG. 7, which does not include an anode active material layer 23, a secondary battery 1a shown in FIG. 8 is obtained, which further includes the anode active material layer 23 formed between the anode current collector 21 and the second intermediate layer 22. The anode active material layer 23 is a lithium metal layer deposited during charging.

For example, during charging of the secondary battery 1, 1a, charging is performed beyond the charge capacity of the intermediate layer 22. That is, the intermediate layer 22 is overcharged. During the initial charging, lithium is absorbed into the second intermediate layer 22. The carbon-based material and/or metal-based material included in the second intermediate layer 22 may form an alloy or compound with lithium ions supplied from the cathode 10. When charging is performed beyond the capacity of the second intermediate layer 22, lithium is deposited, for example, on the backside of the second intermediate layer 22, i.e., between the anode current collector 21 and the second intermediate layer 22, and the deposited lithium forms the anode active material layer 23. The anode active material layer 23 is a metal layer mainly composed of lithium (i.e., metallic lithium). These results are obtained, for example, by including a material that forms an alloy or compound with lithium in the carbon-based material and/or metal-based material included in the second intermediate layer 22. During discharge, lithium from the second intermediate layer 22 and the anode active material layer 23 (i.e., the metallic layer) is ionized and moves toward the cathode 10. In the secondary battery 1a, lithium may serve as the anode active material. Since the second intermediate layer 22 covers the anode active material layer 23, it functions not only as a protective layer for the anode active material layer 23 (i.e., the metallic layer), but also to suppress the deposition and growth of lithium dendrites. The second intermediate layer 22 suppresses short circuits and capacity degradation in the secondary battery 1, 1a, and improves the cycle performance of the battery. When the anode active material layer 23 is formed by charging after assembly of the secondary battery 1, 1a, the anode current collector 21, the second intermediate layer 22, and the region between them constitute a Li-free region, that is a region that does not contain lithium (Li) in the initial state or after discharge of the secondary battery 1, 1a.

Alternatively, referring to FIGS. 6 and 8, the anode active material layer 23 may be disposed, for example, between the anode current collector 21 and the intermediate layer 22 or between the anode current collector 21 and the second intermediate layer 22 during the assembly of the secondary battery 1a. For example, lithium foil may be placed between the anode current collector 21 and the intermediate layer 22 or between the anode current collector 21 and the second intermediate layer 22 during assembly of the secondary battery 1. When the anode active material layer 23 is disposed between the anode current collector 21 and the solid electrolyte layer 30, or between the anode current collector 21 and the intermediate layer 22 during assembly of the secondary battery 1, the anode active material layer 23 functions as a lithium reservoir, as it includes a metal layer containing lithium metal or a lithium alloy. The anode active material layer 23 may include, for example, lithium metal, a lithium alloy, or a combination thereof.

### Method of Preparing a Cathode Mixture

According to another embodiment, a method of preparing a cathode mixture includes mixing a cathode active material with a cathode electrolyte, wherein the cathode electrolyte includes a flame-retardant liquid and an ionic liquid, and the flame-retardant liquid includes a compound represented by Formula 1.

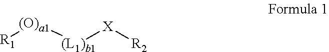

In Formula 1,
R₁ is a C₁-C₁₀ alkyl group substituted with fluorine,
R₂ is a C₁-C₁₀ alkyl group that is unsubstituted or substituted with fluorine,
a1 is an integer of 0 or 1,
b1 is an integer of 0 or 1,
L₁ is a C₁-C₁₀ alkylene group that is unsubstituted or substituted with fluorine, and
X is a carbonyl group (—CO—), an ester group (—COO—), a sulfonate group (—SO₃—), or a sulfonyl group (—SO₂—).

For a description of the cathode active material and the cathode electrolyte, reference is made to the above-described description.

For example, the cathode may be prepared by directly applying and drying a cathode slurry containing the cathode active material onto a cathode current collector to form a cathode active material layer on the cathode current collector.

The cathode electrolyte may be prepared, for example, by mixing an ionic liquid and a flame-retardant liquid.

The mixing of the cathode active material and the cathode electrolyte may be performed, for example, by impregnating the cathode having the cathode active material layer with the cathode electrolyte.

The definitions of substituents used in the chemical formulas are described below.

The term “alkyl,” as used in Formulae, refers to a fully saturated branched or unbranched (i.e., straight-chain or linear) hydrocarbon group.

Non-limiting examples of “alkyl” include methyl, ethyl, n-propyl, isopropyl, n-butyl, isobutyl, sec-butyl, n-pentyl, isopentyl, neopentyl, n-hexyl, 3-methylhexyl, 2,2-dimethylpentyl, 2,3-dimethylpentyl, n-heptyl, and the like.

One or more hydrogen atoms of the “alkyl” group may be substituted with a halogen atom, a C1-C30 alkyl group substituted with a halogen atom (e.g., CCF₃, CHCF₂, CH₂F, CCl₃), a C1-C30 alkoxy group, a C2-C30 alkoxyalkyl group, a hydroxyl group, a C1-C30 alkylthio group, a C1-C30 alkylthioalkyl group, a nitro group, a cyano group, an amino group, an amidino group, a hydrazino group, a hydrazone group, a carboxyl group or a salt thereof, a sulfonyl group, a sulfamoyl group, a sulfonic acid group or a salt thereof, a phosphate group or a salt thereof, or a C1-C30 alkyl group, a C2-C30 alkenyl group, a C2-C30 alkynyl group, a C1-C30 heteroalkyl group, a C6-C30 aryl group, a C7-C30 arylalkyl group, a C2-C30 heteroaryl group, a C3-C30 heteroarylalkyl group, a C2-C30 heteroaryloxy group, a C2-C30 heteroarylthio group, a C3-C30 heteroaryloxyalkyl group, a C6-C30 heteroarylalkyloxy group or C6-C30 heteroarylalkylthio group.

The term “halogen atom” includes fluorine, bromine, chlorine, iodine, or the like.

The term “C1-C30 alkyl group substituted with a halogen atom” refers to a C1-C30 alkyl group substituted with one or more halo groups, and non-limiting examples include polyhaloalkyl groups containing monohaloalkyl, dihaloalkyl or perhaloalkyl.

Monohaloalkyl refers to an alkyl group having one iodine, bromine, chlorine, or fluorine, while dihaloalkyl and polyhaloalkyl refer to an alkyl group having two or more identical or different halo atoms.

The term “alkoxy” as used in Formulae represents alkyl-O—, wherein alkyl is as described above. Non-limiting examples of the alkoxy include methoxy, ethoxy, propoxy, 2-propoxy, butoxy, tert-butoxy, pentyloxy, hexyloxy, cyclopropoxy, cyclohexyloxy, and the like. At least one hydrogen atom in the alkoxy groups may be substituted with the same substituent as in the case of the above-described alkyl group.

The term “alkylthio”, as used in Formulae, represents alkyl-S—, wherein alkyl is as described above. At least one hydrogen atom in the alkylthio groups may be substituted with the same substituent as in the case of the above-described alkyl group.

The term “cycloalkyl” as used in the formula refers to an unsaturated monocyclic or bicyclic organic compound having 4 to 30 carbon atoms in a ring thereof. At least one hydrogen atom in the cycloalkyl groups may be substituted with the same substituent as in the case of the above-described alkyl group.

The term “heterocycloalkyl” group as used in Formulae refers to an unsaturated monocyclic or bicyclic organic compound containing one or more heteroatoms, e.g., N, O, P or S, with the remaining ring atoms being carbon. The heterocycloalkyl group may contain, for example, 1-5 heteroatoms and may contain 5-10 ring members. At least one hydrogen atom in the heterocycloalkoxy groups may be substituted with the same substituent as in the case of the above-described alkyl group.

The S or N may be oxidized and have various oxidation states.

The term “heteroaryl” group as used in Formulae refers to an unsaturated, i.e., aromatic monocyclic or bicyclic organic compound containing one or more heteroatoms, e.g., N, O, P or S, with the remaining ring atoms being carbon. The heteroaryl group may contain, for example, 1-5 heteroatoms and may contain 5-10 ring members. At least one hydrogen atom in the heteroaryl groups may be substituted with the same substituent as in the case of the above-described alkyl group.

The S or N may be oxidized and have various oxidation states.

Examples of monocyclic heteroaryl groups include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl group, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isoxazol-3-yl, isoxazol-4-yl, isoxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, or 5-pyrimidin-2-yl.

The term “aryl” group as used in Formulae, used alone or in combination, refers to an aromatic hydrocarbon containing one or more rings.

The term “aryl” also includes groups in which an aromatic ring is fused to one or more cycloalkyl rings.

Non-limiting examples of the “aryl” include phenyl, naphthyl, tetrahydronaphthyl, and the like.

Additionally, one or more hydrogen atoms of the aryl group may be substituted with substituents as described above for alkyl groups.

The term “arylalkyl” group as used in the Formulae refers to a substituent wherein an aryl group is bonded to an alkyl group, which is itself bound to another atom. For example, benzyl is an arylalkyl group.

The term “arylalkylthio” group as used in the Formulae refers to a substituent wherein an arylalkyl group is bonded to a sulfur atom, which is itself bound to another atom, i.e., arylalkyl-S—, wherein arylalkyl is as described above.

The term “heteroaryl” group, as used in Formulae, refers to a monocyclic or bicyclic organic compound containing one or more heteroatoms, e.g., N, O, P or S, with the remaining ring atoms being carbon. The heteroaryl group may contain, for example, 1-5 heteroatoms and may contain 5-10 ring members.

The S or N may be oxidized and have various oxidation states.

Examples of monocyclic heteroaryl groups include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl group, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isoxazol-3-yl, isoxazol-4-yl, isoxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, or 5-pyrimidin-2-yl.

The term “heteroaryl” includes heteroaromatic rings fused to one or more aryl, cycloaliphatic, or heterocycles.

One or more hydrogen atoms of the “heteroaryl” group may be substituted with substituents as described above for alkyl groups.

The term “heteroaryloxy” as used in Formulae represents heteroaryl-O—, wherein heteroaryl is as described above. The term “heteroarylthio” as used in Formulae represents heteroaryl-S—, wherein heteroaryl is as described above.

The term “heteroarylalkyl” group, as used in the Formulae, refers to a substituent wherein a heteroaryl group is bonded to an alkyl group, which is itself bound to another atom, i.e., heteroaryl-alkyl-. Hereinafter, the disclosure will be described in detail with reference to Examples and Comparative Examples, but is not limited the following examples.

### Preparation of Cathode Electrolyte

### Preparation Example 1

A cathode electrolyte (catholyte) was prepared by mixing an ionic liquid, 1-ethyl-3-methylimidazolium bis(fluorosulfonyl)imide (EMIFSI), with flame-retardant compound 1 in a volume ratio of 1:2, and dissolving lithium salt (LiFSI) at a concentration of 2.0 M into the resulting mixture.

### Preparation Example 2

A cathode electrolyte (catholyte) was prepared by mixing an ionic liquid, 1-ethyl-3-methylimidazolium bis(fluorosulfonyl)imide (EMIFSI), with flame-retardant compound 2 in a volume ratio of 1:2, and dissolving a lithium salt (LiFSI) at a concentration of 2.0 M into the resulting mixture.

### Comparative Preparation Example 1

A cathode electrolyte (catholyte) was prepared by mixing an ionic liquid, 1-ethyl-3-methylimidazolium bis(fluorosulfonyl)imide (EMIFSI), with a fluorinated solvent in a volume ratio of 1:2, and dissolving a lithium salt (LiFSI) at a concentration of 2.0 M into the resulting mixture.

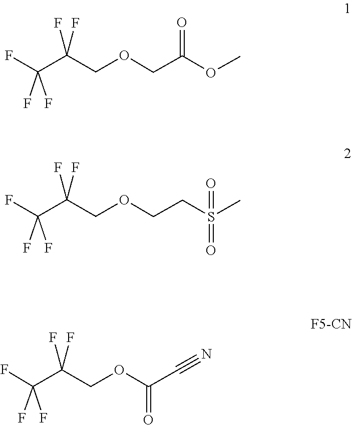

### Example 1

### Cathode Preparation

LiCoO₂ (LCO) was prepared as a cathode active material. Carbon black (Cabot) and graphite (SFG6, Timcal) were prepared as conductive materials. Polytetrafluoroethylene (PTFE) was used as a binder. A mixture was prepared in a mass ratio of 93:3:1:3 (cathode active material: carbon black: graphite: binder). The mixture was stretched into a sheet to form a cathode active material layer sheet. The cathode active material layer sheet was pressed onto an aluminum foil (12 μm thick) serving as a cathode current collector to fabricate the cathode.

A cathode electrolyte was injected onto the cathode active material layer to impregnate the cathode active material layer with the cathode electrolyte.

### Preparation of Solid Electrolyte Layer/Intermediate Layer/Cathode Laminate

A LLZTO pellet (Li_{6.5}La₃Zr_{1.5}Ta_{0.5}O₇, Toshima, Japan) was prepared as a solid electrolyte layer.

A separator (Celgard 3501) was placed on the solid electrolyte layer.

An intermediate layer was prepared by injecting 0.2 mL of an electrolyte solution containing 1.0 M LiFSI (lithium bis(fluorosulfonyl)imide) dissolved in PC (propylene carbonate) into the separator.

On top of the separator, an anode/anode current collector laminate composed of a lithium-copper (Li—Cu) foil which is formed by applying lithium metal (20 μm thick) onto a copper foil (10 μm thick) was placed to form a solid electrolyte layer/intermediate layer/anode laminate.

### Preparation of Secondary Battery

The cathode was placed on the solid electrolyte layer of the solid electrolyte layer/intermediate layer/anode laminate such that the cathode active material layer faced the solid electrolyte layer, and the assembly was sealed in an aluminum pouch under vacuum to prepare the secondary battery.

Terminals were connected to the cathode current collector and the anode current collector, respectively, and extended outside the sealed aluminum pouch to serve as the cathode and anode terminals.

### Example 2

A secondary battery was prepared in the same manner as in Example 1, except that the cathode electrolyte prepared in Preparation Example 2 was used.

### Comparative Example 1

A secondary battery was prepared in the same manner as in Example 1, except that the cathode electrolyte prepared in Comparative Preparation Example 1 was used.

### Evaluation Example 1: Low-Rate Charge/Discharge Test

The charge/discharge characteristics of the secondary batteries manufactured in Examples 1 to 2 and Comparative Example 1 were evaluated by the following charge/discharge test. The charge/discharge test was performed at 25° C.

First Cycle: The battery was charged at a constant current of 0.3 mA/cm² until the battery voltage reached 4.5 V, followed by constant voltage charging until the current dropped to 1/10 of the initial value. Discharge was then performed at a constant current of 0.3 mA/cm² until the voltage reached 2.8 V.

Second Cycle: The battery was charged at a constant current of 0.5 mA/cm² until the battery voltage reached 4.5 V, followed by constant voltage charging until the current dropped to 1/10. Discharge was then performed at a constant current of 0.5 mA/cm² until the voltage reached 2.8 V.

Third Cycle: The battery was charged at a constant current of 1.0 mA/cm² until the battery voltage reached 4.5 V, followed by constant voltage charging until the current dropped to 1/10. Discharge was then performed at a constant current of 1.0 mA/cm² until the voltage reached 2.8 V.

Fourth Cycle: The battery was charged at a constant current of 1.6 mA/cm² until the battery voltage reached 4.5 V, followed by constant voltage charging until the current dropped to 1/10. Discharge was then performed at a constant current of 1.6 mA/cm² until the voltage reached 2.8 V.

Fifth Cycle: The battery was charged at a constant current of 2.0 mA/cm² until the battery voltage reached 4.5 V, followed by constant voltage charging until the current was dropped to 1/10. Discharge was then performed at a constant current of 2.0 mA/cm² until the voltage reached 2.8 V.

Sixth Cycle: The battery was charged at a constant current of 2.5 mA/cm² until the battery voltage reached 4.5 V, followed by constant voltage charging until the current was dropped to 1/10. Discharge was then performed at a constant current of 2.5 mA/cm² until the voltage reached 2.8 V.

A rest period of 10 minutes was applied between each charge and discharge process.

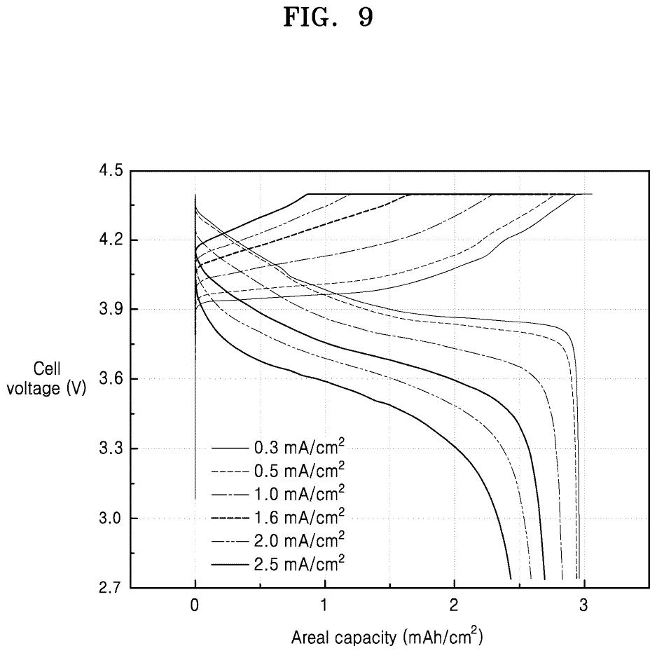

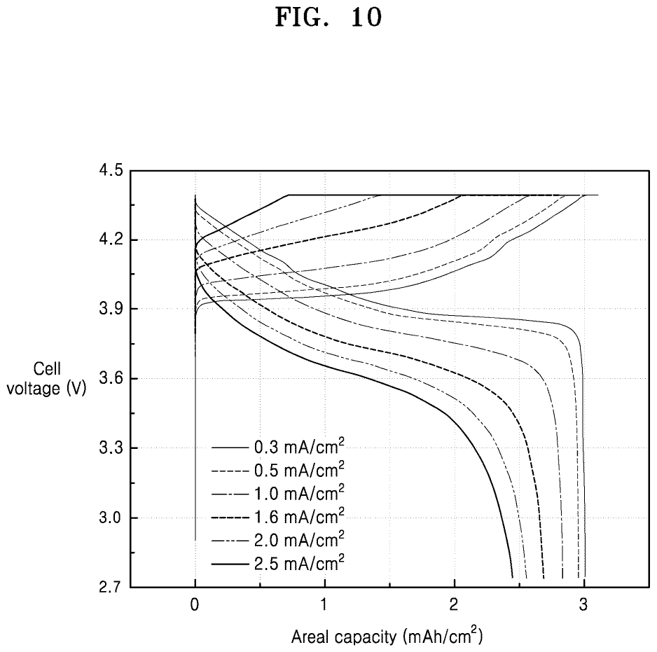

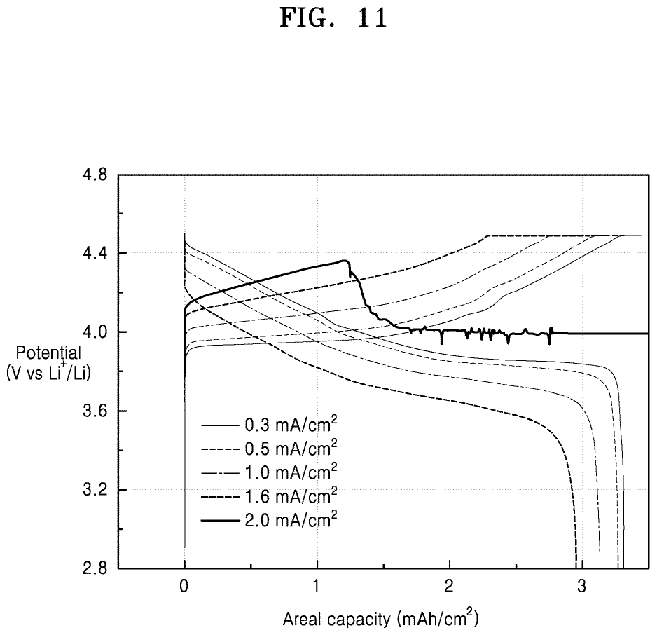

The charge/discharge results of the secondary battery according to Example 1 are shown in FIG. 9. The charge/discharge results of the secondary battery according to Example 2 are shown in FIG. 10. The charge/discharge results of the secondary battery according to Comparative Example 1 are shown in FIG. 11.

Referring to FIGS. 9 and 10, the secondary batteries according to Examples 1 and 2 exhibited stable charge/discharge profiles. Referring to FIG. 11, the secondary battery according to Comparative Example 1 exhibited a short circuit at a current density of 2.0 mA/cm² or higher.

That is, the secondary battery according to the Examples included a cathode electrolyte containing a flame-retardant liquid, which improved the high-rate and high-power characteristics of the secondary batteries. On the other hand, the secondary battery of the Comparative Example, which did not contain a flame-retardant liquid, exhibited deteriorated high-rate and high-power characteristics.

### Evaluation Example 2: XPS Depth Profile Analysis

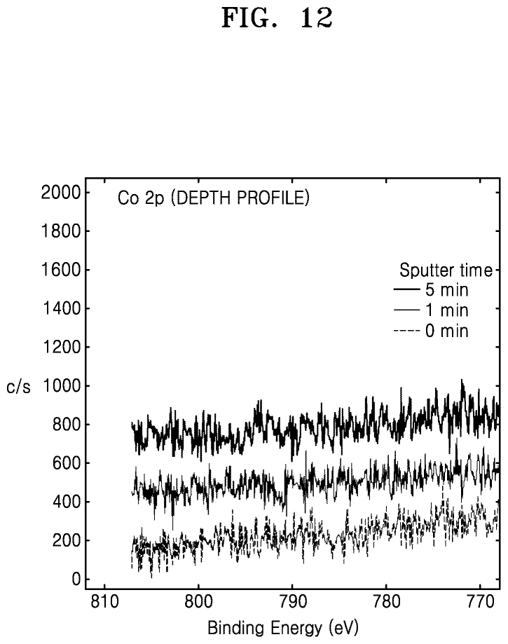

After completing the charge/discharge test described in Evaluation Example 1, the secondary batteries according to Examples 1 and 2 and Comparative Example 1 were disassembled to recover the solid electrolyte. XPS depth profile analysis was performed on the surface of the recovered solid electrolyte. During the analysis, sputtering was carried out to determine the surface composition as a function of depth. Some of the analysis results are shown in FIGS. 12 to 14.

FIG. 12 is an XPS depth profile analysis of the solid electrolyte surface according to Example 1, in which counts per second (intensity) is measures as a function of binding energy (eV) at various sputter times.

The results of the XPS profile analysis indicate that no CoF₂ peak was observed at sputtering times of 0 minutes, 1 minute, or 5 minutes.

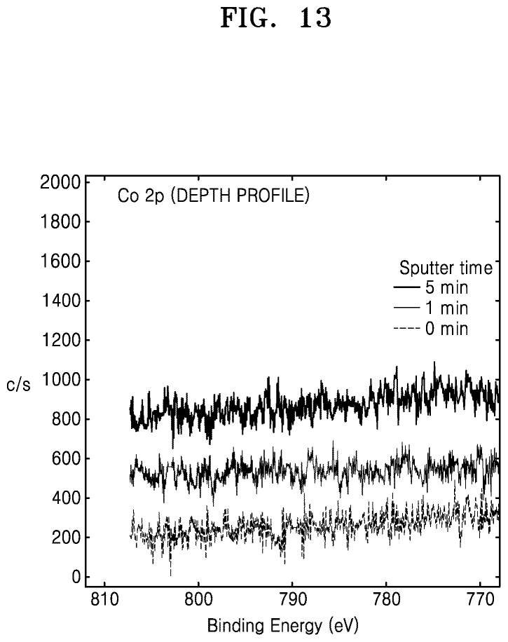

FIG. 13 is an XPS depth profile analysis of the solid electrolyte surface according to Example 2, in which counts per second (intensity) is measures as a function of binding energy (eV) at various sputter times.

The results of the XPS profile analysis indicate that no CoF₂ peak was observed at sputtering times of 0 minutes, 1 minute, or 5 minutes.

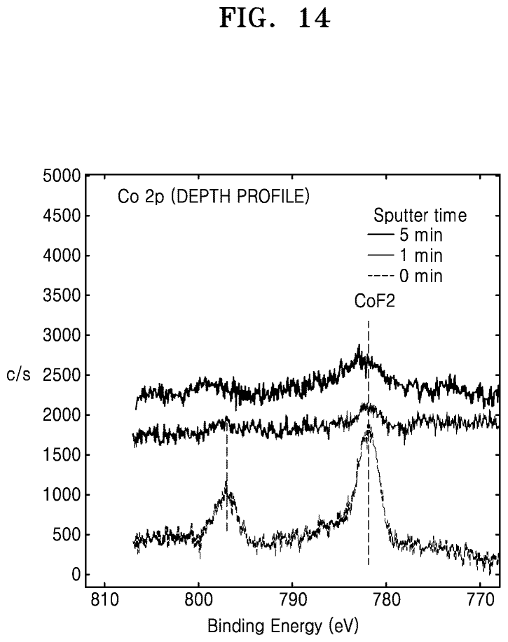

FIG. 14 is an XPS depth profile analysis of the surface of the composite solid electrolyte prepared in Comparative Example 1 in which counts per second (intensity) is measures as a function of binding energy (eV) at various sputter times.

The results of the XPS profile analysis indicate CoF₂ peaks were observed at sputtering times of 0 minutes, 1 minute, and 5 minutes.

Referring to FIGS. 12 to 14, in the secondary batteries according to the Examples, cobalt contained in the cathode active material was not detected on the surface of the solid electrolyte after charge/discharge. In contrast, in the secondary battery according to Comparative Example 1, cobalt from the cathode active material was detected on the surface of the solid electrolyte after charge/discharge. That is, in the secondary batteries of the Examples, the inclusion of a flame-retardant liquid effectively suppressed the elution of transition metals from the cathode active material.

### Evaluation Example 3: XPS Profile Analysis by Position

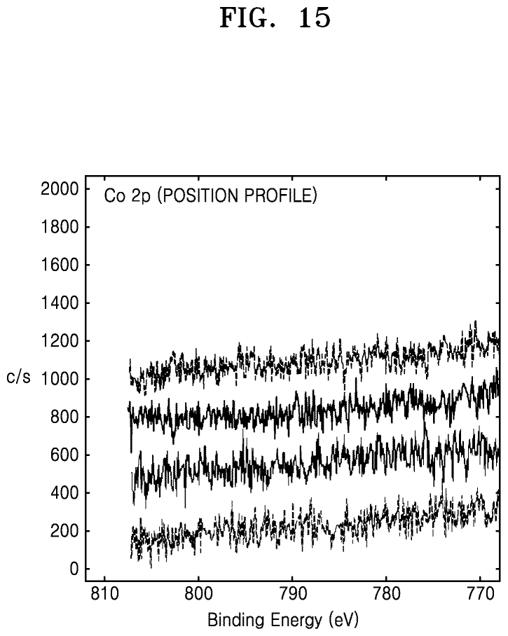

After the charge/discharge evaluations of Evaluation Example 1 were completed, the secondary batteries according to Examples 1 and 2 and Comparative Example 1 were disassembled to recover the solid electrolyte. XPS position profile analysis was conducted on the recovered solid electrolyte surface to analyze the surface composition at different positions while performing sputtering. Some of the analysis results are shown in FIGS. 15 to 17.

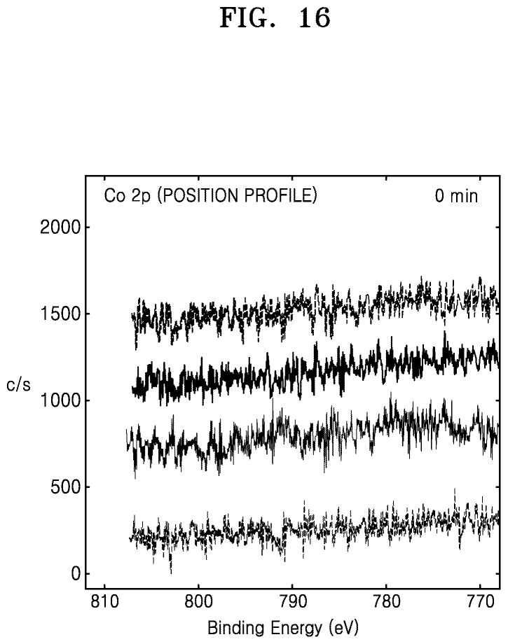

FIGS. 15 and 16 are XPS position profile analysis results of the solid electrolyte surface according to Examples 1 and 2.

As shown in FIG. 15, no CoF₂ peak was observed on the surface of the solid electrolyte of Example 1.

As shown in FIG. 16, no CoF₂ peak was observed on the surface of the solid electrolyte of Example 2.

Therefore, it is determined that cobalt (Co) does not exist on the solid electrolyte surface of Examples 1 and 2 even after charge/discharge.

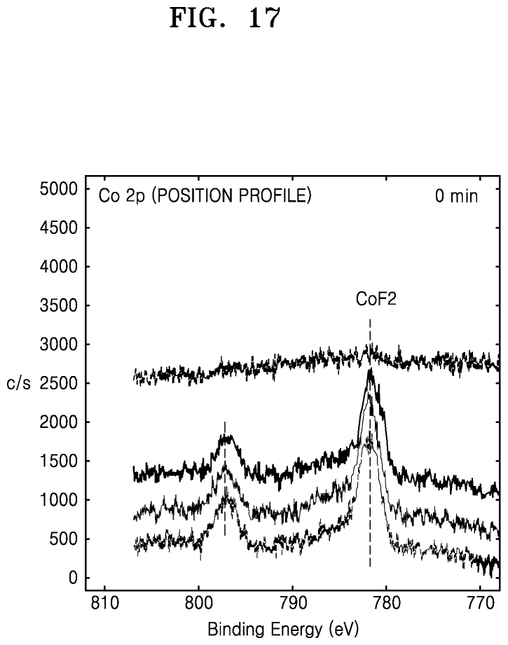

FIG. 17 shows the results of XPS position profile analysis of the solid electrolyte surface according to Comparative Example 1.

As shown in FIG. 17, a CoF₂ peak was observed on the solid electrolyte surface of Comparative Example 1.

Therefore, the results indicate that cobalt (Co) exists on the surface of the solid electrolyte of Comparative Example 1 after charge/discharge.

While exemplary embodiments have been described in detail with reference to the attached drawings, the inventive concept is not limited to these examples. It is self-evident that a person with ordinary skill in the technical field to which the inventive concept belongs may derive various examples of changes or modifications within the scope of the technical idea described in the claims, and these also naturally fall within the technical scope of the inventive concept.

According to an aspect of the disclosure, the cathode mixture prevents the elution of transition metals from the cathode active material, thereby enabling the secondary battery including the cathode mixture to readily exhibit improved charge/discharge characteristics.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A cathode mixture comprising:
a cathode active material; and
a cathode electrolyte,
wherein the cathode electrolyte comprises a flame retardant liquid and an ionic liquid, and
the flame retardant liquid comprises a compound represented by Formula 1: 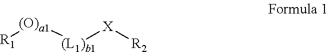
wherein, in Formula 1,
R₁ is a C₁-C₁₀ alkyl group substituted with fluorine,
R₂ is a C₁-C₁₀ alkyl group that is unsubstituted or substituted with fluorine,
a1 is an integer of 0 or 1,
b1 is an integer of 0 or 1,
L₁ is a C₁-C₁₀ alkylene group that is unsubstituted or substituted with fluorine, and
X is a carbonyl group (—CO—), an ester group (—COO—), a sulfonate group (—SO₃—), or a sulfonyl group (—SO₂—).

2. The cathode mixture of claim 1,
wherein in Formula 1,
R₁ is a C₁-C₅ alkyl group substituted with fluorine,
L₁ is a C₁-C₅ alkylene group, and
R₂ is a C₁-C₃ alkyl group that is unsubstituted or substituted with fluorine.

3. The cathode mixture of claim 1,
wherein in Formula 1,
R₁ is —CF₂H, —CF₃, —CH₂CFH₂, —CH₂CF₂H, —CH₂CF₃, —CFHCH₃, —CFHCFH₂, —CFHCF₂H, —CFHCF₃, —CF₂CH₃, —CF₂CFH₂, —CF₂CF₂H, —CF₂CF₃, —CH₂CF₂CF₃, —CF₂CF₂CF₃, —CH₂CF₂CF₂CF₃, —CF₂CF₂CF₂CF₃, —CH₂CF₂CF₂CF₂CF₃, or —CF₂CF₂CF₂CF₂CF₃, and
R₂ is —CH₃, —CF₃, —CH₂CH₃, or —CH₂CF₃.

4. The cathode mixture of claim 1,
wherein the flame retardant liquid comprises at least one of compounds represented by Formulae 1-1 to 1-6: 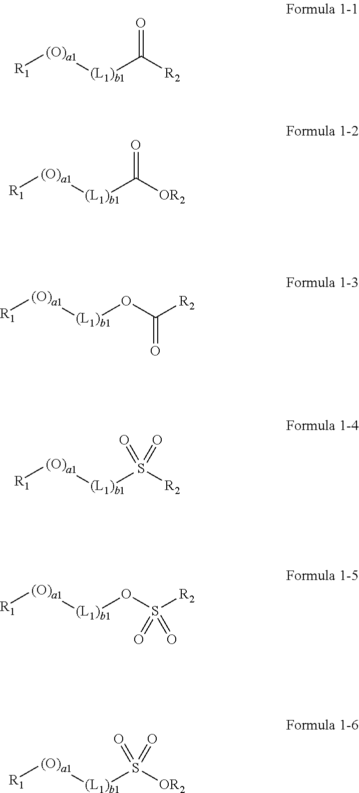
wherein in Formulae 1-1 to 1-6,
R₁, a1, L₁, b1 and R₂ are as described in claim 1.

5. The cathode mixture of claim 1,
wherein a content of the flame retardant liquid is about 1 vol % to about 50 vol %, based on the total volume of the cathode electrolyte.

6. The cathode mixture of claim 1,
wherein the ionic liquid comprises compounds represented by Formulae 2 and 3: 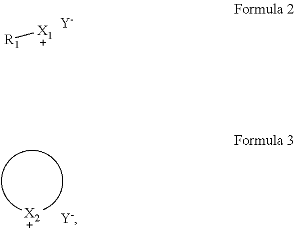
wherein in Formula 2,
X₁ is —N(R₂)(R₃)(R₄) or —P(R₂)(R₃)(R₄),
R₁, R₂, R₃ and R₄ are each independently an unsubstituted or halogen-substituted C1-C30 alkyl group, an unsubstituted or halogen-substituted C1-C30 alkoxy group, an unsubstituted or halogen-substituted C1-C30 alkylthio group, an unsubstituted or halogen-substituted C6-C30 aryl group, an unsubstituted or halogen-substituted C6-C30 arylalkyl group, an unsubstituted or halogen-substituted C6-C30 aryloxy group, an unsubstituted or halogen-substituted C3-C30 heteroaryl group, an unsubstituted or halogen-substituted C3-C30 heteroarylalkyl group, an unsubstituted or halogen-substituted C3-C30 heteroaryloxy group, an unsubstituted or halogen-substituted C3-C30 heteroarylthio group, an unsubstituted or halogen-substituted C4-C30 cycloalkyl group, an unsubstituted or halogen-substituted C3-C30 heterocycloalkyl group, or an unsubstituted or halogen-substituted C2-C100 alkylene oxide group,
wherein in Formula 3, 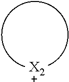
is a heterocycloalkyl ring or a heteroaryl ring containing 1 to 3 heteroatoms and 2 to 30 carbon atoms, wherein the ring is unsubstituted or substituted by a substituent,
X₂ is —N(R₅)(R₆), —N(R₅)═, —P(R₅)(R₆) or —P(R₅)═,
substituents of the ring, R5, and R6 are each independently hydrogen, an unsubstituted or halogen-substituted C1-C30 alkyl group, an unsubstituted or halogen-substituted C1-C30 alkoxy group, an unsubstituted or halogen-substituted C1-C30 alkylthio group, an unsubstituted or halogen-substituted C6-C30 aryl group, an unsubstituted or halogen-substituted C6-C30 arylalkyl group, an unsubstituted or halogen-substituted C6-C30 aryloxy group, an unsubstituted or halogen-substituted C3-C30 heteroaryl group, an unsubstituted or halogen-substituted C3-C30 heteroarylalkyl group, an unsubstituted or halogen-substituted C3-C30 heteroaryloxy group, an unsubstituted or halogen-substituted C3-C30 heteroarylthio group, an unsubstituted or halogen-substituted C4-C30 cycloalkyl group, an unsubstituted or halogen-substituted C3-C30 heterocycloalkyl group, or an unsubstituted or halogen-substituted C2-C100 alkylene oxide group, and
Y⁻ is BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, PF₆⁻, ClO₄⁻, BOB⁻ (bis(oxalate)borate), CF₃SO₃⁻, CF₃CO₂⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, (CF₃SO₂)₂N⁻, or a combination thereof.

7. The cathode mixture of claim 1,
wherein the ionic liquid comprises compounds represented by Formulae 4 and 5: 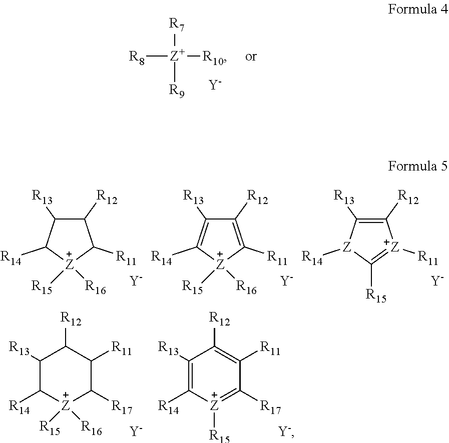
wherein in Formula 4,
Z is N or P,
R₇, R₈, R₉ and R₁₀ are each independently an unsubstituted or halogen-substituted C1-C30 alkyl group, an unsubstituted or halogen-substituted C6-C30 aryl group, an unsubstituted or halogen-substituted C6-C30 arylalkyl group, an unsubstituted or halogen-substituted C3-C30 heteroaryl group, an unsubstituted or halogen-substituted C3-C30 heteroarylalkyl group, an unsubstituted or halogen-substituted C3-C30 heteroaryloxy group, an unsubstituted or halogen-substituted C3-C30 heteroarylthio group, an unsubstituted or halogen-substituted C4-C30 cycloalkyl group, or an unsubstituted or halogen-substituted C3-C30 heterocycloalkyl group,
wherein in Formula 5,
Z is N or P,
R₁₁, R₁₂, R₁₃, R₁₄, R₁₅, R₁₆, and R₁₇ are each independently hydrogen, an unsubstituted or halogen-substituted C1-C30 alkyl group, an unsubstituted or halogen-substituted C6-C30 aryl group, an unsubstituted or halogen-substituted C6-C30 arylalkyl group, an unsubstituted or halogen-substituted C3-C30 heteroaryl group, an unsubstituted or halogen-substituted C3-C30 heteroarylalkyl group, an unsubstituted or halogen-substituted C3-C30 heteroaryloxy group, an unsubstituted or halogen-substituted C3-C30 heteroarylthio group, an unsubstituted or halogen-substituted C4-C30 cycloalkyl group, or an unsubstituted or halogen-substituted C3-C30 heterocycloalkyl group, and
Y⁻ is BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, PF₆⁻, ClO₄⁻, BOB⁻ (bis(oxalate)borate), CF₃SO₃⁻, CF₃CO₂⁻, (FSO₂)₂N⁻, (C₂F₅SO₂)₂N⁻, (C₂F₅SO₂)(CF₃SO₂)N⁻, (CF₃SO₂)₂N⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, C₂N₃⁻, (O(CF₃)₂C₂(CF₃)₂O)₂PO⁻, (FSO₂)₂N⁻, (CF₃SO₂)₂N⁻, or a combination thereof.

8. The cathode mixture of claim 1,
wherein the ionic liquid comprises 1-ethyl-1-methylimidazolium bis(fluorosulfonyl)imide, 1-methyl-1-propylpyrrolidinium bis(fluorosulfonyl)imide, 1-methyl-1-butylpyrrolidinium bis(fluorosulfonyl)imide, 1-methyl-1-propylpyrrolidinium bis(trifluoromethanesulfonyl)imide, 1-methyl-1-butylpyrrolidinium bis(trifluoromethanesulfonyl)imide, 1,3,5-trimethyl-1H-imidazol-3-ium bis(fluorosulfonyl)imide, or a combination thereof.

9. The cathode mixture of claim 1,
wherein a content of the ionic liquid is about 50 vol % to about 99 vol %, based on the total volume of the cathode electrolyte.

10. The cathode mixture of claim 1,
wherein the cathode electrolyte further comprises a lithium salt.

11. The cathode mixture of claim 10,
wherein the lithium salt comprises at least one of LiPF₆, LiBF₄, LiCF₃SO₃, LiC₂F₅SO₃, LiC₄F₉SO₃, LiN(SO₂F)₂ (LiFSI), LiN(CF₃SO₂)₂ (LiTFSI), LiN(SO₂CF₂CF₃)₂, LiSCN, LiN(CN)₂, Li(CF₃SO₂)₃C, LiCl, LiF, LiBr, LiI, LiB(C₂O₄)₂, LiBF₄, LiBF₃(C₂F₅), LiAsF₆, LiSbF₆, LiClO₄, a compound represented by Formulae 6 to 9, or a combination thereof:

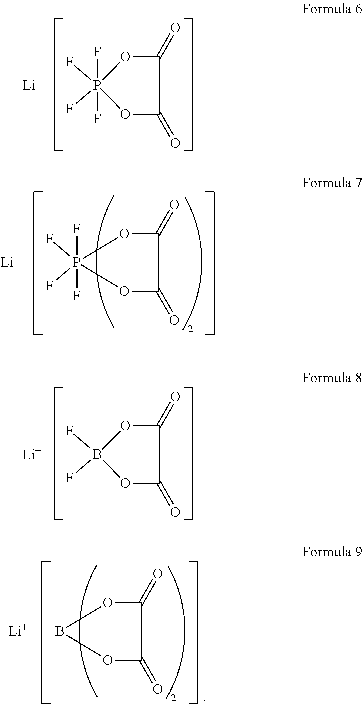

12. The cathode mixture of claim 10,
wherein a content of the lithium salt is about 0.1 M to about 5 M.

13. The cathode mixture of claim 1,
wherein the cathode active material comprises at least one of compounds represented by Formulae 10 to 17: 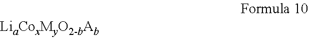
wherein in Formula 10,
1.0≤a≤1.2, 0≤b≤0.2, 0.9≤x≤1, 0≤y≤0.1, and x+y=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br, or a combination thereof, 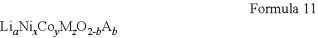
wherein in Formula 11,
1.0≤a≤1.2, 0≤b≤0.2, 0.8≤x<1, 0≤y≤0.3, 0<z≤0.3, and x+y+z=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br, or a combination thereof, 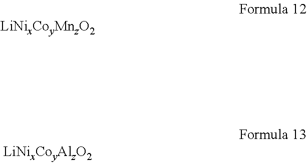
wherein in Formulae 12 and 13, 0.8≤x≤0.95, 0≤y≤0.2, 0<z≤0.2 and x+y+z=1, 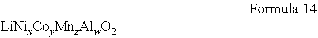
wherein in Formula 14, 0.8≤x<0.95, 0≤y≤0.2, 0<z≤0.2, 0<w≤0.2, and x+y+z+w=1, 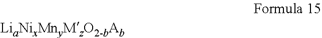
wherein in Formula 15,
1.0≤a≤1.2, 0≤b≤0.2, 0<x≤0.3, 0.5≤y<1, 0<z≤0.3, and x+y+z=1,
M′ is cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br, or a combination thereof, 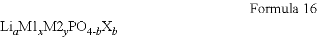
wherein in Formula 16, 0.90≤a≤1.1, 0≤x≤0.9, 0≤y≤0.5, 0.9<x+y<1.1, and 0≤b≤2,
M1 is chromium (Cr), manganese (Mn), iron (Fe), cobalt (Co), nickel (Ni), copper (Cu), zirconium (Zr), or a combination thereof, and
M2 is magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or a combination thereof, and X is O, F, S, P or a combination thereof, 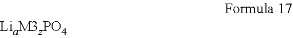
wherein in Formula 17, 0.90≤a≤1.1, 0.9≤z≤1.1, and
M3 is chromium (Cr), manganese (Mn), iron (Fe), cobalt (Co), nickel (Ni), copper (Cu), zirconium (Zr), or a combination thereof.

14. The cathode mixture of claim 1,
further comprising a binder and a conductive material.

15. The cathode mixture of claim 14,
wherein the conductive material comprises carbon black, carbon fiber, graphite, or a combination thereof, and
the binder comprises polyacrylic acid, polyvinylidene fluoride, polyvinyl alcohol, carboxymethyl cellulose, starch, hydroxypropyl cellulose, regenerated cellulose, polyvinylpyrrolidone, tetrafluoroethylene, polyethylene, polypropylene, ethylene-propylene-diene monomer, sulfonated ethylene-propylene-diene monomer, styrene-butadiene-rubber, fluorinated rubber, a copolymer thereof, or a combination thereof.

16. A secondary battery comprising:
a cathode comprising the cathode mixture of claim 1;
an anode; and
a solid electrolyte layer disposed between the cathode and the anode.

17. The secondary battery of claim 16,
wherein the solid electrolyte layer comprises an oxide-based solid electrolyte, a sulfide-based solid electrolyte, a halide-based solid electrolyte, or a combination thereof.

18. The secondary battery of claim 16,
wherein the solid electrolyte layer comprises an oxide-based solid electrolyte,
the oxide-based solid electrolyte comprises lithium phosphorus oxynitride (LiPON), Li₃ₓLa_{(2/3-x)(1/3-2x)}TiO₃ (0.04<x<0.16), Li₁₊ₓAlₓTi₂₋ₓ(PO₄)₃ (0<x<2), Li₁₊ₓAlₓGe₂₋ₓ(PO₄)₃ (0<x<2), Li_{1+x+y}AlₓTi₂₋ₓSi_{y}P_{3-y}O₁₂ (0<x<2, 0≤y<3), BaTiO₃, Pb(Zr, Ti)O₃, Pb₁₋ₓLaₓZr_{1-y}Ti_{y}O₃ (0≤x<1, 0≤y<1), Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(Al, Ga)ₓ(Ti, Ge)₂₋ₓSi_{y}P_{3-y}O₁₂ (0≤x≤1 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M is Te, Nb, or Zr, 1≤x≤10), Li₇La₃Zr₂O₁₂ (LLZO), Li₃₊ₓLa₃Zr₂₋ₐMₐO₁₂ (M is Ga, W, Nb, Ta, or Al, 0<a<2, 1≤x≤10) (M doped LLZO), or a combination thereof, and
the oxide-based solid electrolyte is crystalline, amorphous, glassy, or glass-ceramic.

19. The secondary battery of claim 16,
further comprising a liquid electrolyte disposed between the cathode mixture and the solid electrolyte layer,
wherein the liquid electrolyte comprises a flame retardant liquid and an ionic liquid, and
the flame retardant liquid comprises a compound represented by Formula 1.

20. A method of preparing a cathode mixture, the method comprising
mixing a cathode active material and a cathode electrolyte,
wherein the cathode electrolyte comprises a flame retardant liquid and an ionic liquid, and
the flame retardant liquid comprises a compound represented by Formula 1: 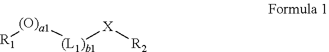
wherein in Formula 1,
R₁ is a C₁-C₁₀ alkyl group substituted with fluorine,
R₂ is a C₁-C₁₀ alkyl group that is unsubstituted or substituted with fluorine,
a1 is 0 or 1,
b1 is 0 or 1,
L₁ is a C₁-C₁₀ alkylene group that is unsubstituted or substituted with fluorine, and
X is a carbonyl group (—CO—), an ester group (—COO—), a sulfonate group (—SO₃—), or a sulfonyl group (—SO₂—).
